(19) United States
(12) Patent Application Publication
(10) Pub. No.: US 2012/0046853 A1
(43) Pub. Date: Feb. 23, 2012

(54) System and Methods for Improved Efficiency Compression Ignition Internal Combustion Engine Control

(76) Inventors: Chester J. Silvestri, Los Gatos, CA (US); Adya S. Tripathi, San Jose, CA (US); Farzad Sahandiesfanjani, San Jose, CA (US)

(21) Appl. No.: 13/213,061

(22) Filed: Aug. 18, 2011

Related U.S. Application Data
(60) Provisional application No. 61/375,720, filed on Aug. 20, 2010.

(51) Int. Cl. F02D 41/30; F02D 41/26; F02D 28/00

(52) U.S. Cl. 701/104

(57) ABSTRACT

The present invention relates to a compression ignition engine control system and methods for improving fuel efficiency. The system includes a fuel processor which receives instructions for a desired engine output and current operating conditions. The fuel processor generates fueling instructions for a plurality of cylinders. The fueling instructions include a low power skip fire mode of operation and a high power mode of operation. The instructions substantially regulate fuel delivery into to a first group of cylinders at or near optimal efficiency fuel levels during each of their respective working cycles. Likewise, the instructions may either substantially disable fuel injection into to a second grouping of cylinders or regulate fuel injection into to the second grouping of cylinders at an elevated high power fuel to air ratio. The fuel processor may include a synchronizer for synchronizing firing of the cylinders with the engine speed. Likewise, the fuel processor may include a sigma delta control circuit for generating a firing pattern that utilizes predictive adaptive control.

### RELATED APPLICATIONS

This application is related to and claims the priority of Provisional Application No. 61/375,720, filed on Aug. 20, 2010.

This application also is related to and claims the priority of U.S. Provisional Patent Application Nos. 61/080,192, filed Jul. 11, 2008; and 61/704,222, filed Oct. 9, 2008. Both of the priority applications are incorporated herein by reference and are entitled: “Internal Combustion Engine Control for Improved Fuel Efficiency.”

This application also is related to and claims priority to U.S. patent application Ser. No. 12/501,345 filed on Jul. 10, 2009, entitled “Internal Combustion Engine Control for Improved Fuel Efficiency”, which is a continuation-in-part of U.S. patent application Ser. No. 12/355,725 filed on Jan. 16, 2009, entitled the same. The content of these applications are incorporated herein by reference.

This application also is related to and claims priority to U.S. patent application Ser. No. 12/501,392 filed on Jul. 10, 2009, entitled “System and Methods for Improving Efficiency in Internal Combustion Engines”. The content of that application is incorporated herein by reference.

### BACKGROUND

The present invention relates to internal combustion engine control systems and methods. More particularly, the present invention relates to systems and methods for controlling a compression ignition internal combustion engine such as a diesel or Homogenous Charge Compression Ignition (HCCl) Engine for the purposes of increasing engine fuel efficiency.

In the diesel (stratified charge compression ignition) engine, only air is initially introduced into the combustion chamber, which is then compressed to a relatively high compression ratio (typically between 12 and 22), resulting in a pressure of approximately 30 bar (600 psi). The high compression heats the air to approximately 550° C. (about 1000° F.). At about this moment, with the exact moment determined by the fuel injector driver, fuel is injected directly into the compressed air inside the combustion chamber. The fuel injector atomizes the fuel and distributes the fuel into the chamber.

The temperature of the compressed air vaporizes fuel from the surface of the droplets of injected fuel; the vapor is, in turn, ignited by the high temperature. The fuel continues to vaporize and burn near the droplet surfaces, until all the fuel in the droplets has been vaporized and then burned. The start of vaporization causes a delay period before ignition. Also, before ignition, some of the vapor premixes with air. When the premixed vapor ignites, the characteristic diesel knocking sound is heard as the igniting premixed vapor causes an abrupt increase in pressure in the chamber above the piston. The rapid increase in pressure then drives the piston downward, supplying power to the crankshaft.

The increase in air pressure and the fact that the diesel engine runs in an effective “unthrottled position” eliminates much of the pumping loss associated with other internal combustion engines, such as Otto cycle gasoline engines. As a result, diesel engines are some of the most efficient engines in use in the world today.

The defining characteristic of HCCl is that the ignition occurs at several places at a time which makes the fuel/air mixture burn nearly simultaneously. There is no direct initiator of combustion. This makes the process inherently challenging to control. However, with advances in microprocessors and an enhanced understanding of the ignition process, HCCl can be controlled to achieve better emissions along with diesel engine-like efficiency.

Recent advances in fuel injector technology have aided in the distribution of diesel fuel at injection. Many modern diesel engines have multi stage fuel injection, whereby varying fuel amounts are pulsed into the combustion chambers. Many fuel injectors include Group Hole Injector Nozzles (GHN), or even multiple injector ports. Proper atomization of fuel enables a more even burn, and thus fewer localized rich fuel burn regions. More even burns tend to decrease pollution of the engine as well as improving engine efficiency since the burns tend to be more complete.

Diesel engines are typically operated under lean conditions (approximately Lambda=1.3). That is, there is much more oxygen (from the air) in the combustion chamber than needed for the combustion of the fuel. This results in combustion products that are low in carbon monoxides and hydrocarbons. This near complete burn and effective minimization of pumping loss associated with Otto cycle engines results in diesel engine's impressive fuel efficiency. However, given today's sensitivity to greenhouse emissions, volatility in fuel prices and fuel supply concerns, increasing fuel efficiency is always advantageous.

In regards to the automotive industry, a number of methods have developed in order to increase engine efficiency. Some measures are subtle, such as optimizing gearing ratios. On the other extreme is the introduction of hybrid systems which combine electric engines and complicated drive train systems with the internal combustion engine.

Overall, such fuel saving measures have improved the efficiency of vehicles. However, there is often a tradeoff of fuel saving features to performance. Also, in regards to some of the more extreme fuel saving features, such as hybrid systems, conversion of existing internal combustion engine vehicles is difficult and often financially prohibitive.

In engines that do not generally throttle the flow of air into the cylinders (e.g., most compression ignition engines) power is controlled by modulating the amount of fuel delivered to the cylinders. Operating such engines at thermodynamically optimal fuel injection levels typically results in the delivery of either more or less power than desired or appropriate at any given time. Therefore, in most applications, standard compression ignition internal combustion engines are operated under conditions well below their optimal thermodynamic efficiency a significant majority of the time.

Given the diesel engine's historical reputation for impressive fuel efficiency as compared to other internal combustion engines (such as Otto Cycle engines), there has been remarkably little done to further increase the fuel efficiency of diesel engines. However, most commercial and consumer diesel engines only achieve around 35-45% efficiency, at best. In practice, under normal driving conditions the fuel efficiency of these vehicles is even lower. Thus, there is large room for improvement of fuel efficiency in diesel and other compression ignition engines.

When designing a system for improving fuel efficiency it is also desirable that the overall cost of the system remains low enough to be justified through fuel expense savings. Likewise, a system which is readily implementable within existing engines is also desirable, thereby allowing the modification of the millions of vehicles on the road currently.

Given the current need for greater fuel efficiency at a reasonable cost to manufacturers and consumers, there is a need for improved diesel engine control systems and methods. Such systems and methods may provide enhanced control of diesel or other compression ignition engines to generate greater fuel efficiency outputs.

In view of the foregoing, systems and methods for improving efficiency compressions ignition engine control are disclosed. The present invention provides a novel system for enabling enhanced control of cylinder fueling and combustion events whereby existing diesel engines may be modified, in a cost effective manner, to satisfy the need for greater fuel efficiency.

### SUMMARY

The present invention discloses a compression ignition engine control system. More particularly, the present invention teaches systems and methods for improving control of compression ignition engines for optimal efficiency operation for the purpose of operating these engines at levels closer to their theoretical maximum thermodynamic efficiency levels. The engine control system may be utilized to modify current engines to operate in advanced skip fire and high power modes where cylinders are activated in order to operate a diesel, or other compression ignition engine, at substantially optimal efficiency levels.

The system may include a fuel processor which receives instructions for a desired engine output. These instructions may be from an accelerator pedal position, or may include other information, such as cruise control settings. In addition, the system may receive current operating conditions. These operational conditions may include engine speed, air intake manifold flux, vehicle weight, slope the vehicle is on, and ambient temperature.

The fuel processor may also generate fueling instructions for the plurality of cylinders. The fueling instructions may include instructions for a low power mode of operation. The low power mode of operation involves “skip fire” in which the instructions substantially regulate fuel delivery into to a first group of cylinders at or near optimal efficiency fuel levels during each of their respective working cycles. Likewise, the instructions may substantially disable fuel injection into to a second grouping of cylinders during each of their respective working cycles.

In another mode of operation, a “high power” mode, the fueling instructions substantially regulate fuel delivery into to a first group of cylinders at or near optimal efficiency fuel levels during each of their respective working cycles. In contrast to skip fire operation, however, the instructions may substantially regulate fuel injection into a second grouping of cylinders at an elevated high-power fuel to air ratio.

Updates to the desired output may also be received. Mode of operation, rate of fire and fueling levels may be dynamically regulated in response to the updated output requirements.

The fuel processor may include a synchronizer configured to synchronize firing of the plurality of cylinders during their working cycles with the engine speed. Likewise, the fuel processor may include a sigma delta control circuit configured to monitor the desired output and adaptively changing the number of cylinders in operation and adaptively varying the fueling of the cylinders in order to deliver the desired output in accordance with variations in the desired output.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A is a structural block diagram for an example of an improved diesel engine control system in accordance with an embodiment of the present invention;

FIG. 1B is a structural block diagram for a second example of an improved diesel engine control system in accordance with an embodiment of the present invention;

FIG. 2 is a structural block diagram for an example of a fuel co-processor of the engine control system in accordance with an embodiment of the present invention;

FIG. 3A is a structural block diagram for a first example embodiment of a drive pulse generator for the fuel processor of the engine control system in accordance with an embodiment of the present invention;

FIG. 3B is a structural block diagram for a second example embodiment of a drive pulse generator for the fuel processor of the engine control system in accordance with an embodiment of the present invention;

FIG. 3C is a structural block diagram for a third example embodiment of a drive pulse generator for the fuel processor of the engine control system in accordance with an embodiment of the present invention;

FIG. 4 is an example structural diagram of a common rail diesel engine in accordance with an embodiment of the present invention;

FIG. 5 is a first example structural diagram of a diesel engine exhaust system in accordance with an embodiment of the present invention;

FIGS. 6A to 6C provide example block diagrams of alternate embodiments of the coupling of the drive pulse generator and the sequencer in accordance with some embodiments of the present invention;

FIG. 7A is a flowchart diagram illustrating an example process for operating a compression ignition engine at high efficiency levels in accordance with an embodiment of the present invention;

FIG. 7B is a flowchart diagram illustrating an example process for receiving the desired engine output when operating a compression ignition engine at high efficiency levels in accordance with an embodiment of the present invention;

FIG. 7C is a flowchart diagram illustrating an example process for receiving the engine information from engine sensors when operating a compression ignition engine at high efficiency levels in accordance with an embodiment of the present invention;

FIG. 7D is a flowchart diagram illustrating an example process for generation of a firing pattern for the desired engine output when operating a compression ignition engine at high efficiency levels in accordance with an embodiment of the present invention;

FIG. 7E is a flowchart diagram illustrating an example process for generating a skip fire pattern at optimal efficiency when operating a compression ignition engine at high efficiency levels in accordance with an embodiment of the present invention;

FIGS. 7F to 7H are flowchart diagrams illustrating example processes for generating fueling instructions when operating a compression ignition engine at high efficiency levels in accordance with an embodiment of the present invention;

FIG. 8 is an example graphical diagram comparing the operation of a diesel engine operating in a conventional mode compared to a high efficiency mode in accordance with an embodiment of the present invention;

FIG. 9A is an example block diagram of an engine control architecture that includes a fuel co-processor in accordance with one embodiment of the present invention;

FIG. 9B is a second example block diagram of an engine control architecture that includes a fuel co-processor in accordance with one embodiment of the present invention;

FIG. 10 is a graph illustrating the concentration of certain pollutants as a function of air/fuel mixture in an internal combustion engine;

FIG. 11 is an example graph illustrating efficiency of an compression ignition internal combustion engine as a function of air to fuel ratios in accordance with one embodiment of the present invention;

FIG. 12 is an example graph illustrating power output of an compression ignition internal combustion engine as a function of air to fuel ratios in accordance with one embodiment of the present invention; and

FIG. 13 includes a series of example graphs illustrating possible operational modes of a compression ignition internal combustion engine in accordance with one embodiment of the present invention.

In the drawings, like reference numerals are sometimes used to designate like structural elements. It should also be appreciated that the depictions in the figures are diagrammatic and not to scale.

### DETAILED DESCRIPTION

The present invention will be described in detail with reference to selected preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. The features and advantages of the present invention may be better understood with reference to the drawings and discussions that follow.

The present invention relates generally to systems and methods for controlling the operation of internal combustion diesel engines to function at higher efficiency levels. In particular, the present invention is directed to novel methods and systems for diesel operation which offers power modulation in an engine running at higher efficiency fuel to air ratios as compared to standard operation.

Also of note is that in the remainder of this application particular attention will be placed upon internal combustion diesel engines for use in automobiles, trucks, locomotive, ship and other vehicular uses. It is important to realize that internal combustion engines are utilized in a wide range of other applications and that the present invention is versatile enough to be utilized in a myriad of applications. This includes small appliance applications, such as portable generators, power washers, compressors and lawn mowers, for example. Additionally, the present invention may be useful in association with industrial applications, such as manufacturing equipment and construction machinery, for example. Likewise, while a diesel style engine is described by way of explanation, the present invention is likewise usable in conjunction with other engine types including Homogenous Charge Combustion Ignition (HCCl) engines and other compression ignition engine types. It is thus intended that the present invention is usable in conjunction with any internal combustion engine regardless of eventual use or application.

The present application describes a number of engine designs and control arrangements for effectively controlling the operation of an engine in manners that permit some of the engine working chambers to operate at higher efficiency levels. The various described embodiments include implementations that are well suited for use in: 1) retrofitting existing engines; 2) new engines based on current designs; and/or 3) new engine designs that incorporate other developments or are optimized to enhance the benefits of the described high efficiency operational capacity.

Below is provided a number of example systems and methods of operation for improved diesel engine control. For the sake of clarity multiple subsections with corresponding headings are provided. These subsections are provided solely in the interest of clarity and are not intended to limit the present invention in any manner.

### I. Improved Diesel Engine Control System

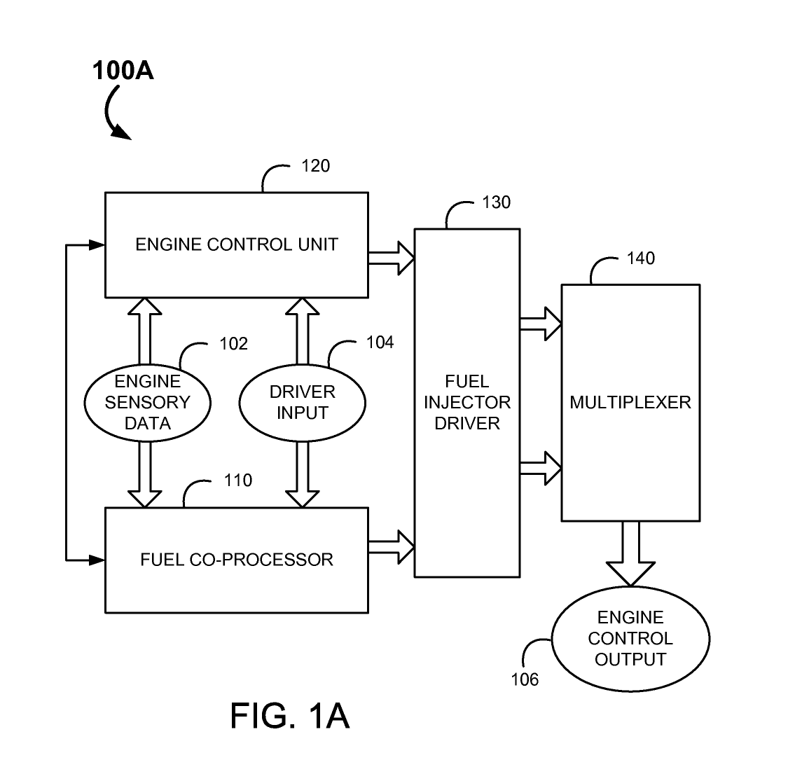

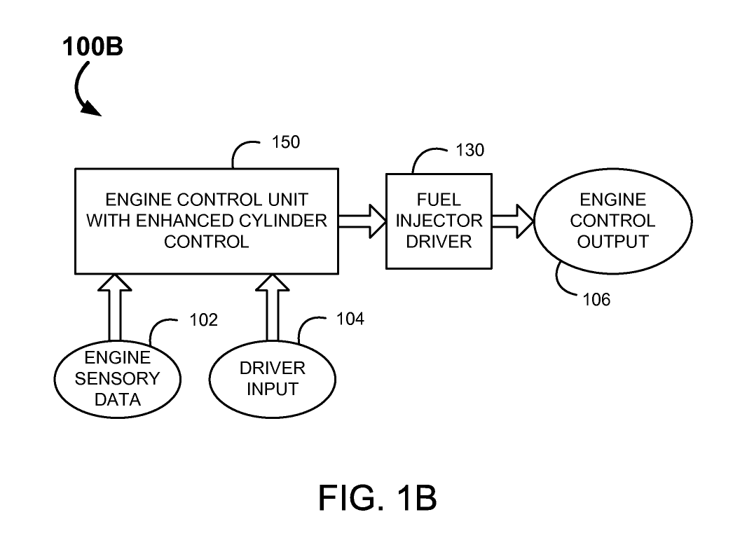

FIG. 1A provides a structural block diagram for an example of an Improved Engine Control System 100A. Portions of the Improved Engine Control System 100A may be preexisting components found within current vehicle engines. For example, most vehicles include an Engine Control Unit 120 and a Fuel Injector Driver 130. Additionally, most engines include means for generating Engine Sensory Data 102 and Driver Input 104. Thus, for many current engines, an aftermarket system including the Fuel Processor 110 and the Multiplexer 140 may be installed which complements the existing Engine Control Unit 120 of the vehicle. This design is particularly well adapted for retrofitting existing engines to incorporate the described high efficiency operating modes.

The described control system may be implemented in a wide variety of different manners. It may be accomplished using digital logic, analog logic, algorithmically or in any other appropriate manner. In some embodiments the high efficiency control logic will be build into the Engine Control Unit 120 (ECU, sometimes also referred to as an ECM, engine control module). In other embodiments, high efficiency mode control logic may be built into the Fuel Processor 110 that is arranged to work in conjunction with an existing Engine Control Unit 120.

It is anticipated that as the technology develops, the high efficiency mode control logic will be integrated into the engine control units that are provided with new vehicles or engines, as illustrated at FIG. 1B. This is particularly beneficial because it allows the ECU to readily take advantage of all of the features of the engine that are available to improve engine control using the high efficiency mode.

New ECUs that incorporate the high efficiency mode and other engine control modes may also be developed for vehicles that are on the road today (and for other existing engines and/or engine designs). When such ECUs are developed the existing engines may readily be retrofitted by simply replacing the existing ECU with an improved ECU that incorporates the enhanced engine control.

Alternatively, as will be appreciated by those familiar with current automotive engine control design, the engine control units in most late model automobiles are arranged such that third party devices may interface with the engine control unit. These interfaces are often provided, at least in part, to facilitate engine diagnostics; however, a variety of third parties products such as turbochargers, superchargers, etc. include control co-processors that have been designed to utilize such interfaces to work with the engines without voiding the manufacturer's warranty. These interfaces may be used advantageously to allow a low cost fuel co-processor that incorporates the enhanced control logic to be installed as a retrofit to enable higher fuel efficiency operation for diesel vehicles on the road today.

When a new vehicle is designed, the entire Improved Engine Control System 100A may be installed. Here the Engine Control Unit 120 and the Fuel Processor 110 may be separate processing devices, or there may be an integrated ECU, as described in FIG. 1B, which incorporates the functionalities of the Engine Control Unit 120 and Fuel Processor 110 in an Engine Control Unit with Enhanced Cylinder Control 150.

The Engine Sensory Data 102 and Driver Input 104 are provided to the Engine Control Unit 120 and Fuel Processor 110 for determining the eventual desired Engine Control Output 106. Engine Sensory Data 102 may include limited information as engine speed, or may include a much wider set of information such as current operational mode, MAF, MAP, Exhaust Oxygen levels, vehicle speed, weight, slope that the vehicle is on, towing load, road friction resistance, ambient humidity, ambient air pressure, ambient temperature, operational information and other relevant vehicle information.

The Driver Input 104 may come from any suitable source that may be considered a reasonable proxy for a desired engine output. For example, the input signal may simply be a signal indicative of accelerator pedal position taken directly or indirectly from an accelerator pedal position sensor. In vehicles that have a cruise control feature, the Driver Input 104 may come from a cruise controller. In still other embodiments, the Driver Input 104 may be a function of several variables in addition to accelerator position. In other engines, that have fixed operational states, the Driver Input 104 may be set based on a particular operational setting. In general, the desired output signal found in the Driver Input 104 may come from any suitable source that is available in the vehicle or engine being controlled.

The Engine Control Unit 120 often includes look up tables for the fuel injection driver. As will be appreciated by those familiar with the art, the designs of the existing ECUs and their respective interfaces vary significantly and accordingly, the Fuel Processor 110 may be adapted and designed to work with the particular ECU provided for the engine.

When operating in a high efficiency mode, the Fuel Processor 110 effectively overrides the fuel injection level instructions calculated by the Engine Control Unit 120, and instead orders the fueling and valve control determined to be appropriate by the Fuel Processor 110. The Fuel Processor 110 also may correct for other inputs (such as the oxygen sensor input when applicable) as appropriate to insure that the rest of the engine's systems run correctly.

In this embodiment, the Fuel Processor 110 and the Engine Control Unit 120 include and/or are coupled to a Fuel Injector Driver 130 for each of the fuel injectors so that the Fuel Processor 110 itself may drive the fuel injectors. Thus, the Engine Control Unit 120 and the Fuel Processor 110 may operate in parallel, with each receiving inputs (i.e. Engine Sensory Data 102 and Driver Input 104) and both determining the appropriate engine control, which are fed to a Multiplexer 140. When the engine is operating in high efficiency mode, the Multiplexer 140 is directed to only deliver the signals received from the Fuel Processor 110 to the fuel injectors (and any other components controlled by the fuel co-processor). Any time the engine is taken out of these enhanced control modes, the Multiplexer 140 is directed to only deliver the signals received from the Engine Control Unit 120 to the fuel injectors (and other components). Any components that are controlled by the Engine Control Unit 120 in both the normal and enhanced control modes may always be controlled directly by the Engine Control Unit 120.

The resulting signal from the Multiplexer 140 may include the Engine Control Output 106. This Engine Control Output 106 may include valve control information, fuel injection control and other information such as oxygen sensor input corrections when applicable.

In FIG. 1B, a single ECU with Enhanced Cylinder Control 150 is illustrated. This Enhanced ECU receives the Engine Sensory Data 102 and Driver input 104 to generate a wide range of output including fuel injection control and cylinder valve controls. The Enhanced ECU 150 may couple to the Fuel injection Driver 130 and produce final Engine Control Output 106.

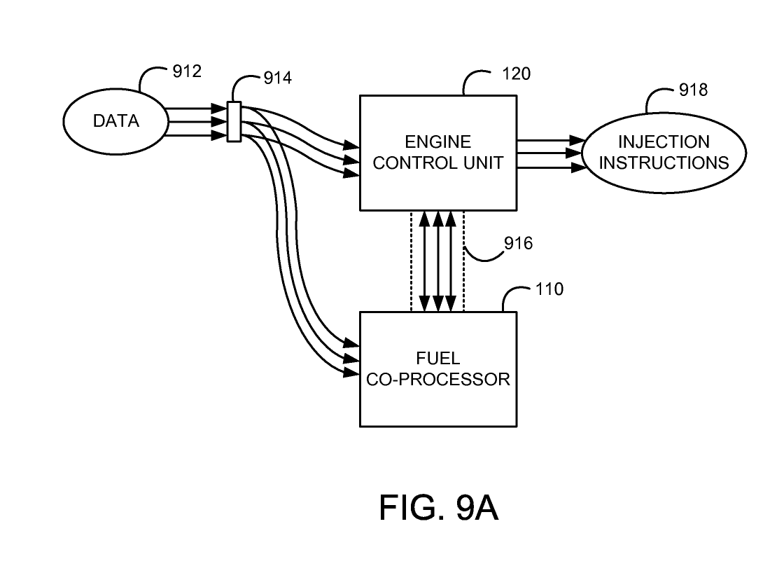

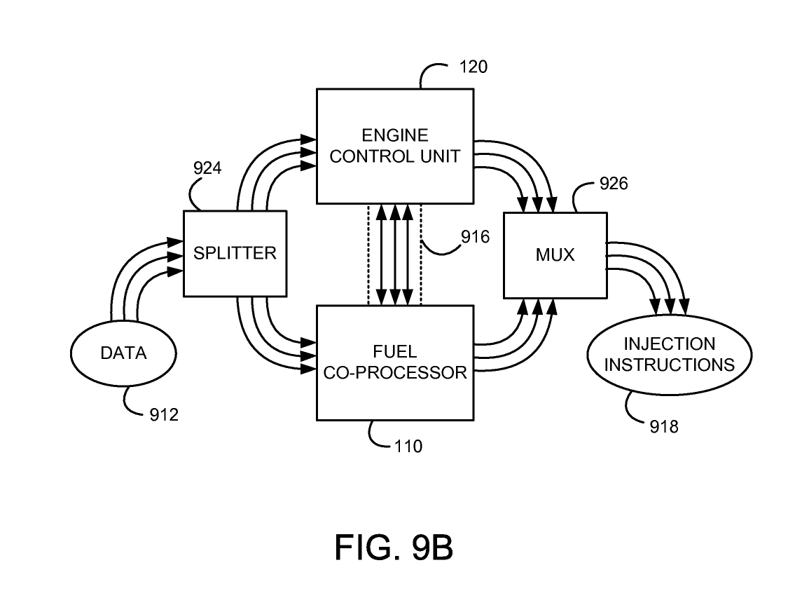

Many methods may exist for wiring the instant invention with an engine control unit. As examples, FIGS. 9A and 9B provide logical wiring and connectivity diagrams for the instant invention.

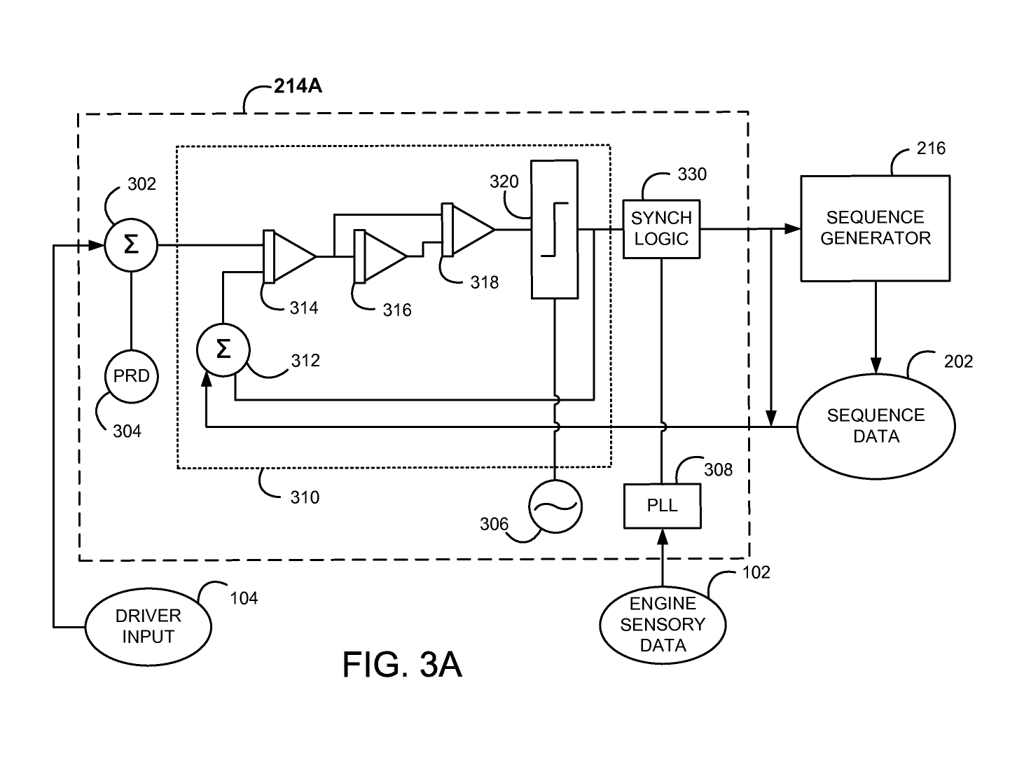

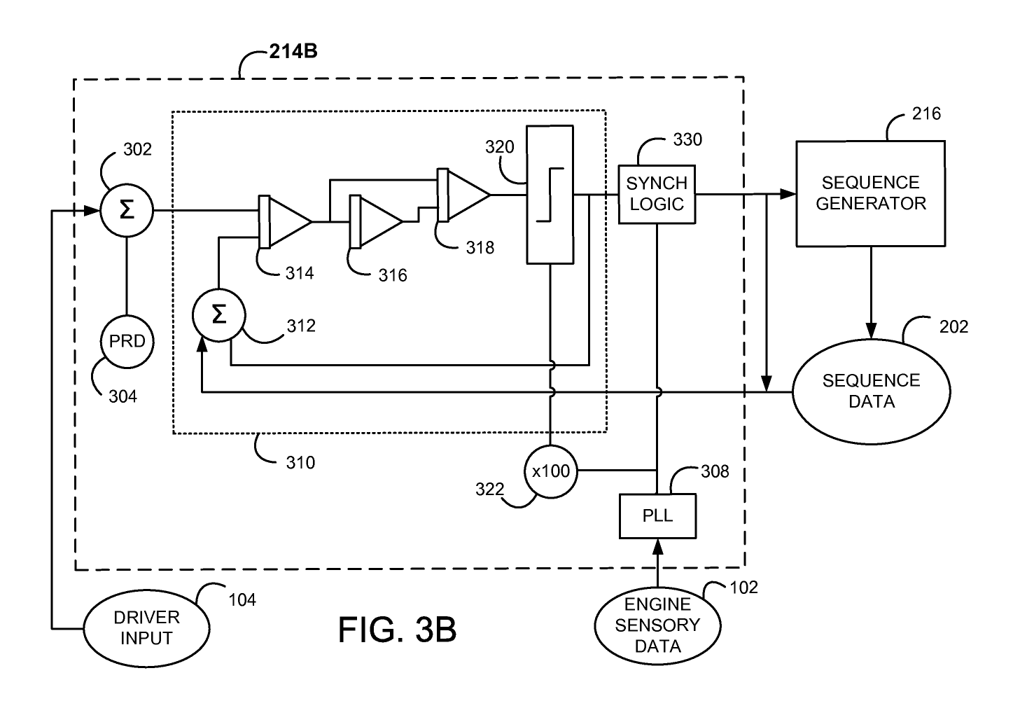

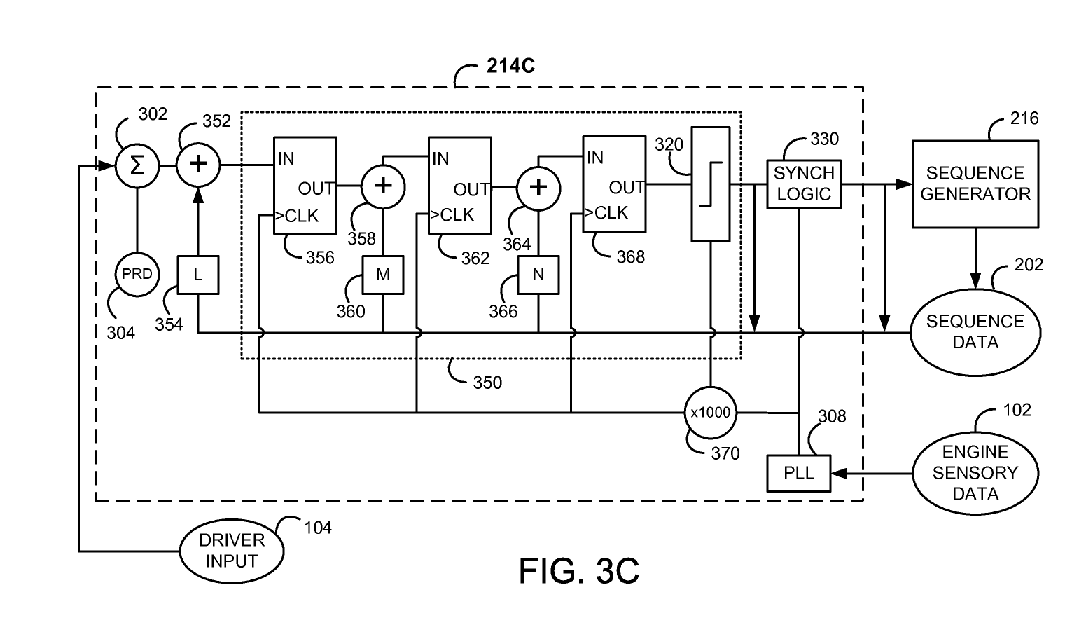

The engine control system of the present invention includes a conventional engine control unit (ECU) 120 and a fuel co-processor 110 that incorporates high efficiency mode control logic such as the logic illustrated in FIGS. 3A-3C below. This design is particularly well adapted for retrofitting existing engines to incorporate the described high efficiency operating mode.

As will be appreciated by those familiar with the art, the designs of the existing ECUs and their respective interfaces vary significantly and, accordingly, the fuel co-processor must be adapted and designed to work with the particular ECU provided for the engine. Conceptually, the ECU typically includes an input cable having a plurality of input lines that deliver the signals and sensor inputs required by the ECU and an output cable that includes a plurality of output lines that deliver the control and other outputs provided by the ECU to other devices. In practice, the input and output cables may be integrated into a single cable bundle or multiple bundles that mix input and output lines, and/or may include some duplexed I/O lines.

As noted above, most late model automotive engine control units (ECUs) have external interfaces that permit third party devices to interact with the ECU. Often, this interface takes the form of a diagnostic interface. The ECU 120 in the embodiment illustrated in FIG. 9A includes an external diagnostics interface 916 and the fuel co-processor 110 communicates with the ECU through the diagnostic interface. Specifically, an ECU bus cable connects the fuel co-processor 110 to the diagnostic interface 916. The input cable is connected to a splitter 914 that delivers the input signals to both the ECU 120 and the fuel co-processor 110. Therefore, the co-processor has all of the information available to it that is available to the ECU. When operating in the high efficiency mode, the fuel co-processor communicates with the ECU over the ECU bus cable and overrides the fuel injection instructions calculated by the ECU, and instead orders the fueling timing and amounts determined to be appropriate by the fuel co-processor. The co-processor also overrides other inputs (such as the oxygen sensor input when applicable) as appropriate to insure that the rest of the engine's systems run correctly.

Another fuel co-processor embodiment is illustrated in FIG. 9B. In the illustrated embodiment, the engine control system includes a conventional engine control unit (ECU) 120, a fuel co-processor 110 that incorporates high efficiency mode control logic and a multiplexor 926. In this embodiment, the fuel co-processor 110, in addition to the ECU 120, includes drivers for each of the fuel injectors so that the fuel co-processor itself can drive the fuel injectors. In this arrangement, as noted above, the ECU 120 and the fuel co-processor 110 operate in parallel, with each receiving inputs from the input cable and both determining the appropriate engine control, which are fed to multiplexor 926. When the engine is operating in the high efficiency mode, the multiplexor 926 is directed to only deliver the signals received from the fuel co-processor 110 to the fuel injectors (and any other components controlled by the fuel co-processor). Any time the engine is taken out of the high efficiency mode, the multiplexor 926 is directed to only deliver the signals received from the ECU to the fuel injectors (and other components). Any components that are controlled by the ECU in both the normal and high efficiency operating modes are always controlled directly by the ECU.

In the embodiment of FIG. 9B, the fuel co-processor 110 communicates with the ECU over ECU bus cable through the diagnostic interface 916 and is arranged to override any input signals that need to be corrected for when the engine operates in the high efficiency mode.

Although specific wirings of the fuel co-processor are illustrated in FIGS. 9A and 9B, it should be appreciated that a wide variety of other wirings and/or couplings may be utilized. For example, in some cases only a portion of input signals may be delivered to the Fuel Processor 110, since some of the input signals may not be relevant to the operation of the Fuel Processor 110. Additionally or alternatively, input signals that are intended to be modified by the Fuel Processor 110 may be wired to first be input to the Fuel Processor 110 and then a (potentially) modified signal may be fed from the Fuel Processor 110 to the Engine Control Unit 120. That is, the Fuel Processor 110 may intercept some or all of the input signals and modify some of those signals as appropriate prior to their delivery to the Engine Control Unit 120.

In still other embodiments, some or all of the output lines may be connected to the Fuel Processor 110 rather than the Engine Control Unit 120. This is particularly appropriate in implementations in which the Fuel Processor 110 is designed to determine the fuel injection and/or valve control in all operations of the engine.

### A. Engine Operation Modes

In some implementations, typically, there are three modalities the engine is capable of operating in: conventional operating mode, skip fire operation, and high power mode. The present invention may solve an optimization problem to determine mode of operation for the engine to maximize fueling efficiency.

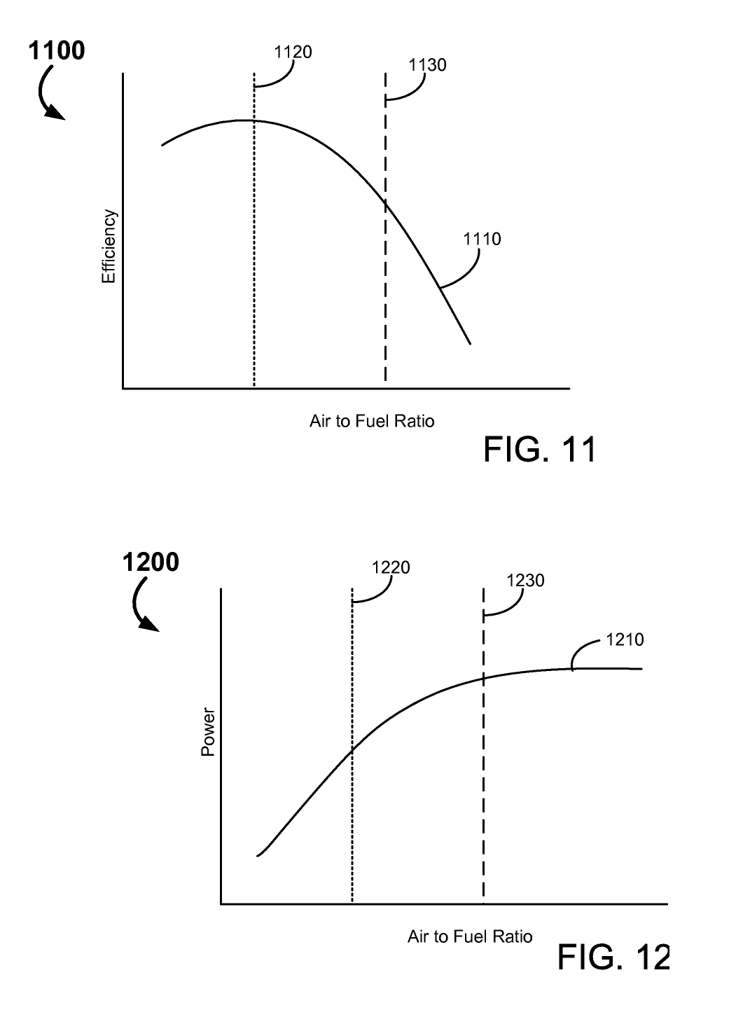

To understand how the multiple modes of operation manage to reduce overall fuel consumption it is beneficial to understand the efficiency profile and power profile of a typical diesel engine operating at various fuel to air ratios. FIGS. 11 and 12 provide example graphs of efficiency and power, respectively, across various fuel-to-air ratios. The graphs of FIGS. 11 and 12 are not drawn to scale to simplify the curve trends.

At FIG. 11, a graph 1100 is illustrated with efficiency of the engine on the vertical axis and air to fuel ratios on the horizontal axis. The efficiency profile 1110 is indicated by the curved line. Stoichiometric air to fuel ratio 1130 is labeled by the vertical large dashed line. Efficiency clearly drops rapidly after stoichiometry as there is no oxygen to consume the added fuel. Thus, further fuel after stoichiometric levels is simply expelled as particulate matter and vapor in the exhaust. Conversely, due to overhead frictional forces, inertial forces and the like, too lean of a fuel to air ratio also looses efficiency. Eventually, friction becomes the dominant force, and the small fuel amount inserted into the cylinders is insufficient to cause continued engine operation. Thus, a “sweet spot” of optimal fuel to air ratio 1120 may be seen, indicated by the small dotted line. The maximum efficiency may vary dependent upon operational conditions and engine design; however, in general this optimal fuel to air ratio falls within the range of fuel required to get roughly 10%-20% of the total power from the engine. The object of the system, then, is to operate the compression ignition engine at or near this optimal fuel to air ratio as often as possible while still providing expected handling and drivability.

Continuing to FIG. 12, a power graph 1200 is illustrated. The power profile 1210 is illustrated leveling off soon after stoichiometric fuel to air ratio is reached. At optimal efficiency 1220, however, power is at a reduced level (as discussed above). Thus, to deal with this reduced power availability the system must be versatile enough to operate in various modes in order to generate needed power levels and yet maintain high efficiency operation.

As noted earlier, there are three modalities the engine is capable of operating in: conventional operating mode, skip fire operation, and high power mode. An optimization problem may be solved to determine the mode of operation of the engine to maximize fueling efficiency.

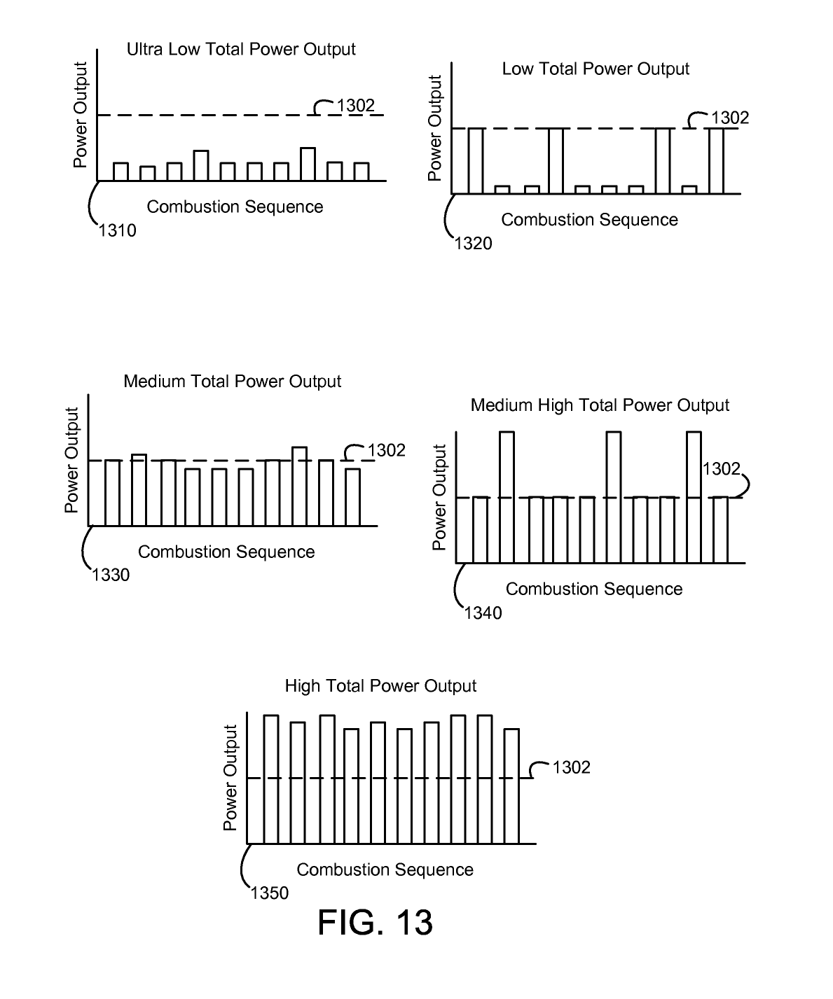

“Conventional operational mode” or “conventional operation” is the manner in which diesel engines currently operate. In this operational state, every cylinder receives fuel at every combustion opportunity. The level of fuel injected into each cylinder is varied for the instant power requirement. Turn briefly to the illustrated graphs of FIG. 13. Here a number of example operational modes are listed corresponding to various power outputs. Graphs 1310, 1330 and 1350 are operating in conventional operational modes. Lines 1302 indicate optimal fueling efficiency. At example graph 1310 the engine speed is so low that conventional operation is required to minimize unwanted vibrations. At example graph 1302 the efficiency differences between other modes of operation and conventional operation are sufficiently small that running the engine in the conventional mode is logical. Lastly, in graph 1350, power requirements are so large that conventional mode of operation is needed in order to generate the power and performance needed.

A “skip fire operation” or simply “skip fire” is a form of variable displacement whereby selected cylinders receive fuel and others do not receive fuel during certain combustion events. In the present invention, those receiving fuel may do so at or near a maximal efficiency level. Again, at FIG. 13, graph 1320 illustrates a skip fire mode of operation. Each combustion event is at optimal efficiency 1302, and power is controlled by skipping some of the combustion events. Thus, in aggregate, total output power is low, even if particular combustion events produce higher instant power output.

As noted before, in some embodiments, this maximal efficiency level is between 10% and 20% of total engine power capacity. For example, in some embodiment a car with a 200 hp diesel engine may run at optimal efficiency if each cylinder receives enough fuel to produce a total engine output of 30 hp. Of course, dependent upon engine design and external conditions this maximal efficiency level may vary. In skip fire mode, power is then modulated by the number and frequency of cylinders receiving fuel and undergoing a combustion event. Returning to the previous example, if the diesel car is cruising on the highway and requires 20 hp of power to maintain speed, the cylinders may be fueled at maximal efficiency two-thirds (⅔) of the time. Thus, every third fueling opportunity may be ‘skipped’ to obtain the desired power output. In a skip fire mode the instant power output varies significantly, however the aggregate power output may be finely controlled. Further, given the large number of firing opportunities (combustion event opportunities) in a relatively short amount of time, these large swings in instant power output are typically unnoticeable by the driver. Thus, from all perceivable standpoints the handling of the vehicle is identical between conventional operation and skip fire operation.

Lastly, a “high power operational mode”, “high power mode” or “high power operation” refers to situations when the required power output for the engine is above the levels the engine is capable of producing when all cylinders are being fueled at their maximum efficiency rates. Again, at FIG. 13, the graph 1340 may indicate an engine operating at high power mode. As can be seen, the majority of combustion events occur at optimal efficiency levels 1302, but a few cylinders are provided greater fuel levels, thus modulating overall power output to a higher level.

Again returning to the previous car example, the diesel car's engine is capable of producing 30 hp when operating at its maximum efficiency levels. However, if the car is going up a hill or accelerating then the required power output may be higher. For example, assume the driver of the car is attempting to pass another vehicle and needs 70 hp output from the engine. There is a 40 hp shortfall between the needed power (70 hp) and that produced by the engine at optimal efficiency (30 hp). In a current engine the cylinders would unanimously receive greater fuel amounts to compensate for this shortfall. The presently described high power mode would instead maintain optimal fuel efficiency to the majority of cylinders and elevate the fuel injected into a relative minority of cylinders to compensate for the shortfall. Returning to the example, assume the engine is a six cylinder engine, thus each cylinder contributes 5 hp when operating at maximum efficiency (30 hp/6 cylinders=5 hp per cylinder). Thus, in one example of the present invention, four cylinders may be run at optimal efficiency, and the remaining two cylinders may be provided more fuel such that they generate 25 hp apiece. This results in a total output of 70 hp that the driver desired (4 cylinders×5 hp/cylinder+2 cylinders×25 hp/cylinder=70 hp). This operational state may, under particular conditions, enable the engine to produce the required power output with reduced overall fuel consumption.

It is important to note that the foregoing examples are hypothetical situations which ignore many of the nuances of engine function for the sake of example simplicity. For example, each cylinder may produce different power outputs, or power output per cylinder may range dependent upon engine and environmental factors (such as engine speed and elevation). The present invention is robust enough to detect these complexities of engine function in determining the number and ratio of cylinders which are to be utilized.

Also, note that the instant power output in either skip fire or high power modes varies greatly, and that only when looking at power output in aggregate is the power output equivalent to the desired power output. The relative speed of engine operation renders these power fluctuations imperceptible to the driver. In order to function smoothly, however, a robust mechanism of adaptive predictive control is required. This system requires appropriate feedback including engine RPM (rotations per minute) and wheel speed, as well as feed forward information. The feed forward enables the preemptive determinations required for adaptive predictive control.

As stated earlier, an optimization problem may be solved in order to determine which mode of operation the engine should be in to maximize fuel efficiency.

### B. Fuel Processor

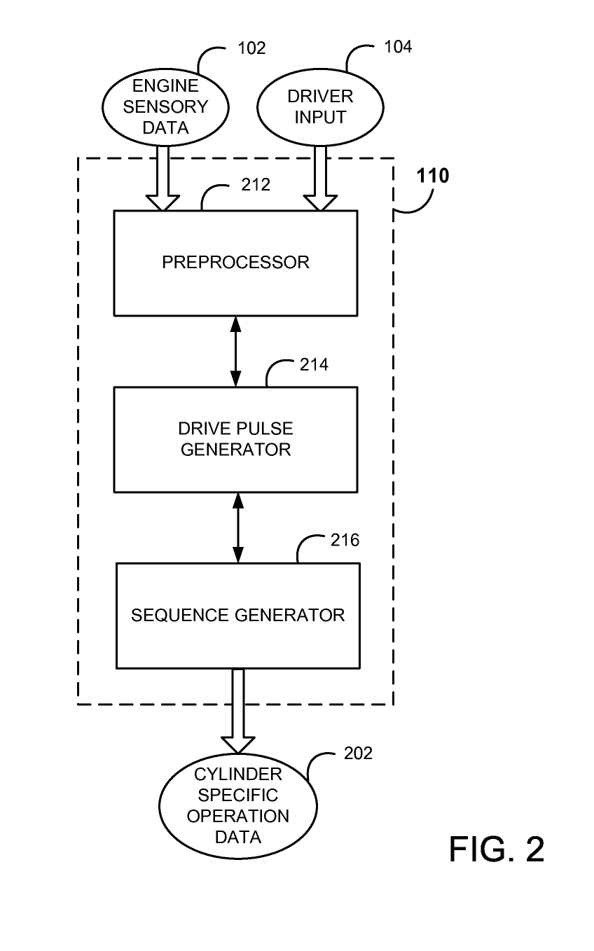

FIG. 2 is a structural block diagram for an example of the Fuel Processor 110 of the Improved Engine Control System 100A. In the illustrated embodiment, the Fuel Processor 110 includes a Preprocessor 212, a Drive Pulse Generator 214 and a Sequence Generator 216. The Engine Sensory Data 102 and the Driver Input 104 may be provided to the Preprocessor 212.

In some of the embodiments described, a signal from the accelerator pedal position is treated as the indication of the desired engine output that is used as the input to the control system (e.g., drive pulse generator 214, engine control unit 120, etc). In such embodiments, the desired engine output signal (driver input 104) may be taken directly from a pedal position sensor on the vehicle, or it may be amplified in an appropriate manner. In other embodiments, the pedal position sensor signal may be combined with other inputs (such as the dither signal described below) before it is provided to the drive pulse generator 214. In yet other embodiments, the accelerator pedal position sensor signal may be provided to the Preprocessor 212, which either generates its own signal or does some level of processing on the pedal sensor signal. The output of the Preprocessor 212 may then be used as the input to the drive pulse generator, with or without an additional dither signal as may be appropriate for a particular design.

The Preprocessor 212 may be arranged to provide any desired type of preprocessing of the accelerator pedal position sensor signal. For example, it may be desirable for an automobile to provide a fuel savings mode where the accelerator pedal position signal is preprocessed in a way that helps operate the engine in the most fuel efficient manner. In another example, it is generally known that some drivers tend to relatively rapidly fluctuate the pedal position. For such drivers it may be desirable for an automobile to provide a smooth driving mode in which a preprocessor averages or smoothes certain pedal position fluctuations (e.g., the preprocessor may take the form of, or include a low pass filter). In still other implementations, the vehicle may include a cruise controller. In such vehicles, the cruise controller may be incorporated in the preprocessor or may serve as the source of the drive pulse generator's input signal when the vehicle is in the cruise control mode. In still other embodiments, anti-aliasing filtering of the pedal position may be provided in the Preprocessor 212. Of course, the preprocessor may be arranged to perform any other type of preprocessing that is deemed appropriate for the engine and/or vehicle being controlled. The preprocessor may, in some embodiments, determine the operational mode that the engine is to work in.

The Drive Pulse Generator 214 may be arranged to use adaptive predictive control to dynamically calculate a drive pulse signal that generally indicates when firings at specific fueling levels are required to obtain the desired output. As will be discussed in more detail below, the controller may be synchronized with the engine speed (part of Engine Sensory Data 102) so that the generated drive pulse pattern is appropriate to deliver the power desired at the current engine speed, which may be constantly changing.

The drive pulse signal may then be provided to a Sequence Generator 216 that orders the pulses to provide the final Sequence Data 202. Generally, the Sequence Generator 216 may be arranged to order the combustion pattern in a manner that helps prevent excessive or inappropriate vibration within the engine. As is well known in the engine design field, the order in which cylinders are fired may have a significant effect on vibrations within many engines. Therefore, as will be described in more detail below, the Sequence Generator 216 is designed to help insure that vibrations generated by the operation of the engine are within design tolerances. If a particular engine is enabled to be run using an arbitrary firing pattern (i.e., the cylinders may be fired in any pattern without generating undue vibrations), then the sequencer may potentially be eliminated and the Drive Pulse Generator 214 could be used to dictate the firing pattern.

Note that while “firing patterns” and “firing” of the cylinders is disclosed, in diesel and HCCl style engines such an ignition event is caused by the introduction of fuel into the heated compressed cylinder. Thus, fueling may be considered synonymous with firing in compression ignition engines.

The Drive Pulse Generator 214 is generally arranged to determine the number and general timing of cylinder combustion events that are required to generate the desired output given the current operating state and operating conditions of the engine. The Drive Pulse Generator 214 uses feedback control, such as adaptive predictive control to determine when cylinders must be fueled to deliver the desired engine output. Thus, the drive pulse signal outputted by the Drive Pulse Generator 214 effectively indicates the instantaneous displacement required by the engine to deliver the desired engine output.

The power output required by the engine will vary with operating conditions and may be based on both what has happened in the past and what is predicted for the immediate future. In various embodiments, the Drive Pulse Generator 214 is generally not constrained to limit fluctuations in the number of cylinder firings that are required per revolution of the crankshaft to deliver the desired output. Thus, the effective displacement of the engine may be continuously varied by selecting which cylinders to fire and which cylinders not to fire, and fueling levels to initiate these firing events on a firing opportunity by firing opportunity basis. This ability to continuously vary the effective displacement of the engine is sometimes referred to herein as a continuously variable displacement mode of operation.

A variety of different control schemes may be implemented within the Drive Pulse Generator 214. Generally, the control schemes may be implemented digitally, algorithmically, using analog components or using hybrid approaches. The drive pulse generator may be implemented on a processor, on programmable logic such as an FPGA, in circuitry such as an ASIC, on a digital signal processor (DSP), using analog components, etc.

One class of controllers that is particularly well suited for use in the drive pulse generator is adaptive predictive controllers. As will be appreciated by those familiar with control theory, adaptive predictive controllers are adaptive in that they utilize feedback to adapt or change the nature of their output signal based on the variance of the output signal from a desired output signal and predictive in that they are integrative so that past behavior of the input signal affects future output signals.

A variety of different adaptive predictive controllers may be used to calculate the chamber firings required to provide the desired output. One class of adaptive predictive controllers that work particularly well in this application is sigma delta controllers. The sigma delta controller may utilize sample data sigma delta, continuous time sigma delta, algorithm based sigma delta, differential sigma delta, hybrid analog/digital sigma delta arrangements, or any other suitable sigma delta implementation. In some embodiments, the sigma delta controller's clock signal is arranged to vary proportionally with the engine speed. In other implementations, a variety of other adaptive predictive controllers including pulse width modulation (PWM), least means square (LMS) and recursive least square (RLS) controllers may be used to dynamically calculate the required chamber firings.

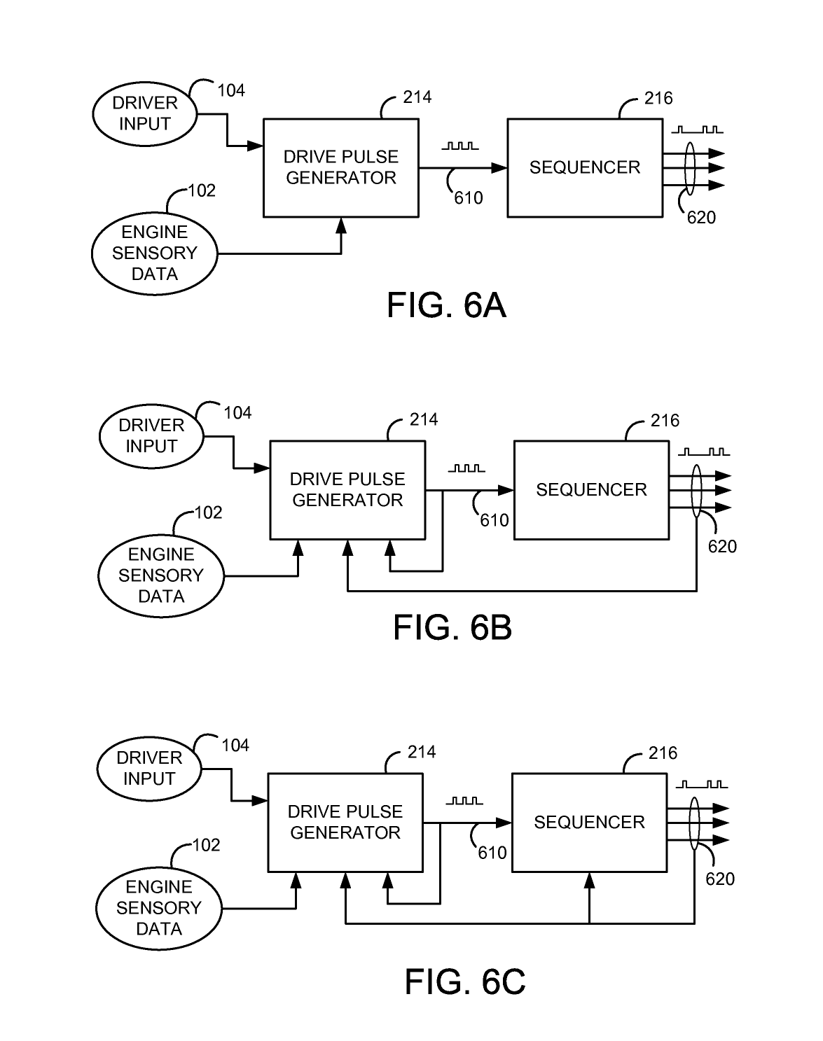

Looking now at FIGS. 6A, 6B and 6C, various feedback architectures may exist for the Fuel Processor 110. FIG. 6A provides a functional block diagram that diagrammatically illustrates the drive pulse generator 214 and a sequencer 216. An input signal 104 that is indicative of a desired engine output is provided to the drive pulse generator 214. The drive pulse generator 214 may be arranged to use adaptive predictive control to dynamically calculate a drive pulse signal 610 that generally indicates when cylinder firings are required to obtain the desired output. As will be discussed in more detail below, the controller may be synchronized with the engine speed (Engine Sensory Data 102) so that the generated drive pulse pattern is appropriate to deliver the power desired at the current engine speed, which may be constantly changing. The drive pulse signal 610 may then be provided to a sequencer that orders the pulses to provide the final cylinder firing pattern 620.

In a first implementation, each cylinder that is fired is operated at or near its optimal thermodynamic efficiency. That is, air and fuel are introduced into the cylinder in amounts that allow the most work to be obtained from the cylinders per unit of fuel burnt while still meeting other constraints on the engine (such as emissions requirements, the effects of the combustion on engine life, etc.). In most combustion ignition engines, this corresponds approximately to a lean fueling (roughly 10%-20% engine power). Many vehicles include engine control units (ECUs) that determine (among many other things) the desired air/fuel ratios and the amount of fuel to be injected for each cylinder firing. Often the ECUs have lookup tables that identify the desired air fuel ratios and/or fuel injection amounts for a number of different operating conditions (e.g. engine speeds, manifold air flow, etc.) based on various current ambient conditions (including air pressure, temperature, humidity etc.). In such vehicles, the amount of fuel that the firing control unit causes to be injected into each cylinder in the continuously variable displacement mode may be the value stored in the fuel injection lookup table for operating the cylinder at full throttle under the current conditions.

The drive pulse generator 214 is generally arranged to determine the number and general timing of cylinder firings that are required to generate the desired output given the current operating state and operating conditions of the engine. The drive pulse generator uses feedback control, such as adaptive predictive control to determine when cylinders must be fired to deliver the desired engine output. Components of the feedback may include feedback of the drive pulse signal 610 and/or feedback of the actual cylinder firing pattern 620 as generally illustrated in FIG. 6B. Since the drive pulse signal 610 indicates when working chamber firings are appropriate, it may generally be thought of as a signal indicative of requested firings. The sequencer then determines the actual timing of the requested firings. When desired, the information fed back from the actual firing pattern 620 may include information indicative of the firing pattern itself, the timing of the firings, the scale of the firings and/or any other information about the cylinder firings that is desired by or useful to the drive pulse generator 214. Generally, it is also desirable to provide the drive pulse generator 214 with an indication of the engine speed (included in the Engine Sensory Data 102) so that the drive pulse signal 610 may generally be synchronized with the engine.

Various feedbacks may also be provided to the sequencer 216 as desired. For example, as illustrated diagrammatically in FIG. 6C, feedback or memory indicative of actual firing timing and/or pattern 620 may be useful to the sequencer to allow it to sequence the actual cylinder firings in a manner that helps reduce engine vibrations.

### C. Drive Pulse Generators

As previously noted the Drive Pulse Generator 214 may be any adaptive predictive controller capable of generating a firing pattern for the engine. Sigma Delta circuits have been found to be particularly suited for this, and below are provided a number of possible embodiments suitable for the Drive Pulse Generator 214.

FIG. 3A is a structural block diagram for a first example embodiment of a sigma-delta control based Drive Pulse Generator 214A for the Fuel Processor 110. The Drive Pulse Generator 214 includes a sigma-delta controller 310 and a synchronizer. The sigma-delta controller 310 utilizes principles of sigma-delta conversion, which is a type of oversampled conversion. (Sigma-delta conversion is also referred to as delta-sigma conversion.) The basic theory of sigma-delta conversion has been described in what is commonly referred to as a seminal reference on the subject: H. Inose, Y. Yasuda, and J. Murakami, “A Telemetering System by Code Modulation: Δ-Σ Modulation,” IRE Transactions on Space Electronics Telemetry, Vol. SET-8, September 1962, pp. 204-209. Reprinted in N. S. Jayant, Waveform Quantization and Coding, IEEE Press and John Wiley, 1976, ISBN 0-471-01970-4.

The illustrated sigma-delta control circuit 310 is an analog third order sigma-delta circuit generally based on an architecture known as the Richie architecture. Sigma-delta control circuit 310 receives an analog input signal that is indicative of a desired output (which might be thought of as desired work output or desired torque). Since sigma-delta controllers of the type illustrated are generally known and understood, the following description sets forth the general architecture of a suitable controller. However, it should be appreciated that there are a wide variety of different sigma-delta controllers that may be configured to work very well for a particular implementation.

In the illustrated embodiment, the desired output is indicative of accelerator pedal position as included in Driver Input 104 (although as described above, other suitable input signals indicative of, or proxies for, desired output may be used as well). The input signal is provided as a positive input to the sigma-delta control circuit 310, and particularly to a first integrator 314. The negative input of the integrator 314 is configured to receive a feedback signal that is a function of the output such that the operation of the sigma delta control circuit 310 is adaptive. As will be described later, the feedback signal may actually be a composite signal that is based on more than one output stage. The integrator 314 may also receive other inputs such as dither signal 304 which also will be described in more detail below. In various implementations some of the inputs to integrator 314 may be combined prior to their delivery to the integrator 314 or multiple inputs may be made directly to the integrator. In the illustrated embodiment, the dither signal 304 is combined with the input signal by an adder 302 and the combined signal is used as the positive input. The feedback signal is a combination of feedback from the output of the sigma delta control circuit and the controlled system.

The sigma delta control circuit 310 includes two additional integrators, integrator 316 and integrator 318. The “order” of the sigma delta control circuit 310 is three, which corresponds to the number of its integrators (i.e., integrators 314, 316 and 318). The output of the first integrator 314 is fed to the second integrator 316 and is also fed forward to the third integrator 318.

The output of the last integrator 318 is provided to a comparator 320 that acts as a one-bit quantizer. The comparator 320 provides a one-bit output signal that is synchronous with a clock signal. Alternatively, the output may include a multi-bit output which includes pulse amplitude variations. The amplitude may correspond to the eventual level of fuel provided to the cylinder at the fueling event. Alternatively, a downstream logic circuit may be configured to interpret signal pulses and generate fueling levels.

Generally, in order to insure very high quality control, it is desirable that the clock signal (and thus the output stream of the comparator) have a frequency that is many times the maximum expected firing opportunity rate. For analog sigma delta control circuits, it is typically desirable for the output of the comparator to oversample the desired drive pulse rate by a factor of at least about 10 and oversampling factors on the order of at least about 100 works particularly well. That is, the output of the comparator 320 is preferably at a rate of at least 10 times and often at least 100 times the rate at which engine firing opportunities occur. The clock signal provided to the comparator 320 may come from any suitable source. For example, the clock signal is provided by a crystal oscillator 306.

It should be appreciated that these clock rates are actually relatively slow for modern digital electronic systems and are therefore readily obtainable and usable. For example, if the controlled engine is a eight-cylinder engine that operates using a four stroke working cycle, then the maximum firing opportunity rate expected might be something on the order of 8,000 RPM×8 cylinders×½. The factor of ½ is provided because, in a normally-operating four-cycle engine, each cylinder has a combustion opportunity only once every two revolutions of the engine crankshaft. Thus, the maximum expected frequency of firing opportunities may be approximately 32,000 per minute, or about 533 per second. In this case, a clock operating at about 50 kHz would have nearly 100 times the maximum expected rate of firing opportunities. Therefore, a fixed clock having a clock frequency of 50 kHz or greater would work very well in that application.

In other embodiments, the clock used to drive the comparator may be a variable clock that varies proportionally with engine speed. It is believed that the use of a variable speed clock in a sigma delta controller is different than conventional sigma delta controller design. The use of a variable speed clock has the advantage of insuring that the output of the comparator is better synchronized with the engine speed and thus the firing opportunities. The clock may readily be synchronized with the engine speed by utilizing a phase lock loop that is driven by an indication of engine speed (e.g., a tachometer signal).

The one-bit output signal outputted from the comparator 320 is generated by comparing the output of the integrator 318 with a reference voltage. The output is effectively a string of ones and zeros that is outputted at the frequency of the clock. The output of the comparator 320 (which is the output of the sigma delta control circuit 310 is provided to a synchronizer that is arranged to generate the drive pulse signal. In the illustrated embodiment, the sigma delta control circuit 310 and the synchronizer together constitute a drive pulse generator 214.

The synchronizer is generally arranged to determine when drive pulses should be outputted. The drive pulses are preferably arranged to match the frequency of the fueling opportunities so that each drive pulse generally indicates whether or not a particular working cycle of a working chamber should be exercised. In order to synchronize the drive pulse signal with the engine speed, the synchronizer operates using a variable clock signal that is based on engine speed from the Engine Sensory Data 102. A phase-locked loop 1208 may be provided to synchronize the clock with the engine speed. Preferably, the clock signal has a frequency equal to the desired frequency of the outputted drive pulse signal. That is, it is preferably synchronized to match the rate of combustion opportunities.

The output signal of the sigma-delta control circuit is generally a digital representation of the analog input signal that is received by the sigma-delta control circuit 310. The digital output signal from the sigma delta control circuit 310 contains a certain number of “high” symbols it is appropriate to generate a positive drive pulse (i.e., to order the fueling of a working chamber). Thus, conceptually, a purpose of the synchronizer may be thought of as being to count the number of high symbols in the output signal and when enough symbols are counted, sending a drive pulse that is synchronized with the engine speed. Additionally, the amplitude of drive pulses may be used to dictate fueling levels. In practice, true counting is not actually required (although it may be done in some implementations). Additionally, the number of chambers utilized for a desired application may be calculated from the number of “high” symbols generated over a set period of time.

Another characteristic of the output of the described sigma-delta control circuit with a high oversampling rate when used in this type of engine control application is that the controller tends to emit long blocks of high signals followed by blocks of low signals. This characteristic of the output signal may be used to simplify the design of the synchronizer. In one implementation, the synchronizer merely measures the length (i.e., time or period) of the blocks of high signals emitted in output signal. If the length of the block of high signals exceeds a designated threshold, a drive pulse is generated. If the length of a block of high signals doesn't exceed the threshold—no drive pulses are generated based on that block of high signals. The actual thresholds that are used may be widely varied to meet the needs of a particular design. For example, in some designs the threshold may be the period of the clock signal which (since the clock is synchronized with the engine speed) corresponds to the duty cycle of the drive pulse pattern and the average delay between working chamber firing opportunities. With this arrangement, if the length of a block of high signals is less than one duty cycle, no drive pulses are generated corresponding to the block; if the length of the block exceeds one duty cycle and is less than two duty cycles, then one drive pulse is generated; if it exceeds two duty cycles but is less than three duty cycles, then two sequential drive pulses are generated; and so on. This mode of operation is particularly useful when the engine is operating in a skip fire type mode of operation.

Many of the same principles map equally well to the high power mode of operation. Here the synchronizer may have a higher threshold of what number of “high” pulses results in an output signal to compensate for the continuous firing of the majority of cylinders at optimal efficiency. Resulting output signals may then indicate the need to provide a cylinder with a higher fuel amount. In some embodiments, every output signal may have an amplitude modulation indicating the designated fuel amount.

It should be appreciated that with this arrangement, the “length” or time duration of a burst of high outputs from the sigma-delta control circuit will have to be longer in order to trigger a drive pulse when the engine speed is low than the length of a burst would need to be in order to trigger a drive pulse when the engine speed is high. That is because the duty cycle of the drive pulse signal is longer at lower engine speeds.

In other implementations, the threshold may be set differently. For example, the thresholds might be set such that any block of high outputs having a length that exceeds some designated percentage (e.g., 80 or 90 percent) of the duty cycle of the drive pulse signal causes a drive pulse to be generated, while shorter pulse lengths are effectively truncated.

At first review it may seem that ignoring portions of pulses in the manner suggested above could degrade the performance of the control system to an unacceptable level. However, for many engines, the high frequency of the firing opportunities and the responsiveness of the control system in general make it perfectly acceptable to use such simple synchronizers. Of course, it should be appreciated that a wide variety of other synchronization schemes may be used as well.

It should be appreciated that although the comparator output, the drive pulse signal and the actual fueling pattern are all related, their timing will vary and the general magnitude of the comparator output may differ from the others. The most accurate feedback in terms of reflecting actual engine behavior is the fueling pattern; however, there may be significant time delays (from the standpoint of the sigma-delta control circuit 310) between the output of the comparator and the actual combustion event of a working chamber. The next best feedback in terms of reflecting actual engine behavior is the drive pulse signal. Thus, in many implementations it will be desirable to heavily weight the feedback towards the drive pulse signal and/or the fueling pattern. However, in practice, the performance of the sigma delta controller may often be enhanced by feeding back some portion of the comparator output signal.

In some embodiments, it may be desirable to anti-aliasing filter the input signal and the feedback signal. The anti-aliasing functionality may be provided as part of the sigma-delta control circuit 310 or it may be provided as an anti-aliasing filter that precedes the sigma delta control circuit or it may be provided in any other suitable form. In the third order analog continuous time sigma-delta control circuit 310 illustrated in FIG. 3A, the first integrator 314 may provide the anti-aliasing functionality. That is, it effectively acts as a low pass filter.

Another known characteristic of sigma delta controllers is that they sometimes generate “tones” which are cyclic variations in the output signal relative to the input signal. Such tones are particularly noticeable when the analog input signal varies slowly, which is often the case when driving and in many other engine control applications. The presence of such tones within the comparator output signal may be reflected in the engine firing pattern. In some situations, there is a risk that such cyclic variations in the drive pattern may generate undesirable resonances within the engine which may generate undesirable vibration patterns. In extreme cases, the tones could even be manifested as a noticeable fluctuation in drive energy. Accordingly, various arrangements may be provided in an effort to help prevent and/or break up such tones. One option that may help prevent and/or break up tones in the sigma-delta controller output is to combine the input signal with a noise signal (“dither”) that averages to zero over time, but whose local variations tend to break up the tones in the output signal of the sigma delta controller. A pseudo-random dither generator (PRD) 304 may be employed to generate the dither signal, but it should be appreciated that dither may be introduced using a wide variety of other approaches as well.

The output of the synchronizer is the drive pulse signal discussed above. The drive pulse signal effectively identifies the cylinder combustion events brought about by cylinder fueling (or instantaneous effective engine displacement) that is needed to provide the desired engine output. That is, the drive pulse signal provides a pattern of pulses that generally indicates when cylinder fueling is appropriate to provide the desired or requested engine output. In theory, the cylinders could be fueled directly using the timing of the drive pulse signal outputted by the synchronizer. However, in many cases it will not be prudent to fuel the cylinder using exactly the same timing as pulse pattern because this could generate undesirable vibrations within the engine. Accordingly, the drive pulse signal may be provided to the Sequence Generator 216 which determines an appropriate fueling pattern. The Sequence Generator 216 is arranged to distribute the cylinder combustion events called for in a manner that permits the engine to run smoothly without generating excessive vibrations.

In still other embodiments differential sigma delta controllers may be used. In such embodiments the synchronizer may be arranged to generate drive pulse patterns based on the differential signals outputted by the sigma delta controller. A wide variety of different differential sigma delta controllers may be used and generally they may include the variable clock and/or multi-bit comparator output features discussed above when desired. One advantage of differential sigma delta controllers is that they may often be configured to provide even smoother performance than a corresponding non-differential sigma delta controller.

FIG. 3B is a structural block diagram for a second example embodiment of a Drive Pulse Generator 214B for the Fuel Processor 110. This alternative embodiment of the drive pulse generator incorporates a variable clock sigma delta controller 310. The drive pulse generator 214B has a structure very similar to the drive pulse generator 214A described above with reference to FIG. 3A. However, in this embodiment, the clock signal provided to the comparator 320 is a variable clock signal that is based on engine speed. The clock signal is generally synchronized with the engine speed by utilizing a phase lock loop 308 that is driven by an indication of engine speed (e.g., a tachometer signal).

As described above, it is desirable for the sigma delta controller to have a sampling rate, and therefore an output signal frequency that is substantially higher than the desired frequency of the drive pulse pattern outputted by the synchronizer 330. Again, the amount of oversampling can be widely varied. As indicated above, oversampling rates on the order of 100 times the desired drive pulse frequency work well and accordingly, in the illustrated embodiment a divider 322 is arranged to divide the clock signal provided to the synchronizer logic by a factor of 100, and the output of the divider 322 is used as the clock for comparator 320. This arrangement causes the output of the comparator 320 to have a frequency of 100 times the frequency of the drive pulse pattern that is output by the synchronizer 330. Of course, in other embodiments, the divider can be arranged to divide the signal by any integer number that provides sufficient oversampling. In other respects, the other components of the sigma delta controller 310 may be the same as described above with respect to FIG. 3A. Any of the designs of the synchronizer 330 and/or the sequencer 216 discussed above or a variety of other synchronizer and sequencer designs may also be used with variable clock sigma delta controller 310. One advantage of synchronizing the output of the sigma delta controller 310 with the engine speed is that it permits simpler synchronizer designs.

This embodiment of a sigma delta controller output may be configured to output a multi-bit signal. The multi-bit output of the sigma delta controller is used by the synchronizer 330 to generate partial drive pulses. In this embodiment, the sigma delta controller 310 may have a design similar to any of the previously described embodiments, however the comparator 320 is arranged to output a multiple bit signal. In some described embodiments, the comparator 330 is two bit comparator and accordingly the output signal is a two bit signal. However, in other embodiments higher bit comparators may be provided which would result in higher bit output signals. The actual number of bits used can be varied to meet the needs of any particular application.

The various states of the multi-bit output signal can each be set to have an associated meaning For example, in a two bit comparator, a 0,0 output signal might reflect a zero output; a 1,1 output signal might be a full signal output—e.g. one; a 0,1 might be arranged to represent a ¼ signal; and a 1,0 might be arranged to represent a ½ signal. Thus, firing and amount of fueling may be coded as well as engine operation modality. Of course a two-bit comparator may readily be designed to have the various states represent different levels than the 0, ¼, ½, and 1 levels suggested above. In higher order comparators, many more states would be available. For example, in a three-bit comparator, 8 states would be available; in a four-bit comparator 16 states would be available, etc. Thus, with a comparator with sufficient bits, say a five-bit, a fine granularity of fueling amount instructions, operational modes and fuel injection timing may be coded by the output.

As will be appreciated by those familiar with multi-bit comparator sigma delta design, the comparator 320 may be configured to output some (generally controllable) percentage of the non-zero samples as intermediate level signals. These intermediate signals can be treated by the synchronizer 330 and the sequencer 216 as corresponding to requests for partial energy drive pulses and reduced energy firings (i.e. varied fuel amounts). For example, if the sigma delta controller 310 outputs a string of one half (IA) level output signals that is sufficiently long to cause the synchronizer 330 to generate a drive pulse, the outputted drive pulse can be a half energy drive pulse. The half energy drive pulse, in turn, is used by the sequencer 216 to direct a half energy fueling. The same type of logic can be used for other (e.g., quarter) level output signals. When the comparator output is a multi-bit output, the synchronizer and the sequencer may readily be arranged to handle and output corresponding multi-bit signals.

It should be appreciated that multi-bit comparator sigma delta controllers are typically arranged to generate extended strings of symbols having the same state. Therefore, any of the general sequencer logics described above can be used to output drive pulses having the same state as the signal fed to the synchronizer 330. That is, the drive pulse outputted by the synchronizer may be arranged to match the level of the signal input into the synchronizer that caused generation of the drive pulse.

Again, it should be appreciated that the logic of the synchronizer 330 can be optimized and widely varied to meet the needs of any particular application. In some applications it may be desirable to provide more sophisticated synchronizer logic to handle specific situations in a desired manner. For example, different logic may be provided to handle situations where the signal inputted to the synchronizer transitions from a higher level to a lower non-zero level that is held through the end of a drive pulse period. In some implementations it may be desirable to have the drive pulse output at the lower level in such situations. Similarly, when the signal transitions from a lower non-zero level to a higher non-zero level, it may be desirable to provide specific logic to dictate what happens in such circumstances.

It should be appreciated that the thermodynamic (and fuel) efficiency of the engine will be best when the working chambers are operated at their optimal efficiency. The optimal efficiency for typical compression ignition internal combustion engines is roughly between 10% and 20% of total power output of the engine. However, engine design and ambient conditions may vary this range of optimal efficiency. Therefore, it is generally desirable to have as many cylinders firings at this fueling level as possible.

The comparator and synchronizer logic may also be arranged to take engine speed and/or the operational state of the engine (e.g. cold start, etc.) into account when determining the percentage of intermediate comparator output signals and/or partial drive pulses to output. For example, when the engine is idling or cold starting, it may be desirable to only output intermediate signals from the comparator so that only partial drive pulses are generated in those situations. It should be appreciated that the comparator and/or synchronizer logic may be arranged to accommodate a wide variety of different desired operational rules.

FIG. 3C is a structural block diagram for a third example embodiment of a Drive Pulse Generator 214C for the Fuel Processor 110. The Drive Pulse Generator 214C illustrated includes a digital third order sigma delta control circuit 350. In this embodiment, accelerator pedal position indicator signal (as part of Driver Input 104) is inputted to a first digital integrator 356. The output of the first digital integrator 356 is fed to a second digital integrator 362 and the output of the second digital integrator 362 is feed to a third digital integrator 368. The output of the third digital integrator 368 is fed to a comparator 320 that may be arranged to operate in the same manner as either the single bit or multi-bit comparators described above with respect to the analog sigma delta circuits. In the embodiment illustrated in this example the first digital integrator 356 effectively functions as an anti-aliasing filter.

Negative feedback is provided to each of the three digital integrator stages 356, 362 and 368. The feedback may come from any one or any combination of the output of the comparator 320, the output of the synchronizer logic or the output of the Sequence Generator 216. Each stage feedback has a multiplication factor (354, 360 and 366) of L, M, and N respectively.

Like the analog sigma delta control circuits described above, the primary input to the digital sigma delta control circuit may be an indication of the accelerator position or any other suitable proxy for desired output (from Driver Input 104). As previously described, the desired output signal is combined with pseudo random dither signal 304 in the illustrated embodiment in order to reduce the possibility of generating undesirable tones.

The primary difference between analog and digital operation is that the integrators in analog sigma delta are continuously active, whereas the digital integrators are only active at the beginning of each clock cycle. In some implementations, it may be desirable to run the clock at a very high speed. However, that is not a requirement. Since the output that is ultimately desired has a frequency that is equal to the fueling opportunities that are being controlled, the clock may be synchronized with the fueling opportunities which may eliminate the need for (or simplify the function of) the synchronizer and/or the Sequence Generator 216. Thus, when a digital controller is used, the controller design may be simplified by running the clock at the frequency of the fueling opportunities being controlled.

Although analog and digital controllers have been described, it should be appreciated that in other implementations, it may be desirable to provide hybrid analog/digital sigma delta controllers. In a hybrid analog/digital controller, some of the stages of the sigma delta controller may be formed from analog components, while others may be formed from digital components. One example of a hybrid analog/digital sigma delta controller utilizes an analog integrator 314 as the first stage of the controller, in place of the first digital integrator 356. The second and third integrators are then formed from digital components. Of course, in other embodiments, different numbers of stages may be used and the relative number of analog vs. digital integrators may be varied. In still other embodiments, digital or hybrid differential sigma delta controllers may be used.

In still other embodiments differential sigma delta controllers may be used. In such embodiments the synchronizer can be arranged to generate drive pulse patterns based on the differential signals outputted by the sigma delta controller. A wide variety of different differential sigma delta controllers may be used and generally they may include the variable clock and/or multi-bit comparator output features discussed above when desired. One advantage of differential sigma delta controllers is that they can often be configured to provide even smoother performance than a corresponding non-differential sigma delta controller.

In some circumstances it may be advantageous to operate in a mode that may be referred to as an implied differential sigma delta. In such a mode, either the synchronizer or the sequencer (or both) are constrained to limit the drive pulses and/or chamber firings to one at a time. That is, in this mode, each fired working chamber is constrained to be followed by a skipped firing opportunity (and/or each drive pulse is constrained to be followed by null pulse). This implied differential sigma delta is particularly useful when the engine is operating at a level where significantly less than 50% of the firing opportunities are required to deliver the desired engine output since it can help further smooth the engine output by insuring that two firings do not immediately follow one another when the required output is relatively low.

In some implementations it may be desirable to operate the engine in an implied sigma delta mode during some operational conditions, in a different type of continuously variable displacement mode during other operational conditions, in a conventional operating mode during still other operational conditions and a high power mode during yet other conditions, as was described above. Of course, the number and nature of the various operational modes may be widely varied. Therefore, it should be appreciated that the engine controller may generally be arranged to operate in a variety of different operational modes during different operational conditions.

The constraints provided by implied sigma delta may also be widely varied. For example, when very low engine outputs are required, there may be instances when it is desirable to constrain the firings pattern to skip at least two firing opportunities after each firing. In other instances it may be desirable to allow two firings to follow one another, but not three. In still other instances, it may be desirable to require a firing any time a designated number of skips follow one another. Generally, it should be appreciated that the firing pattern for a particular engine may be constrained by the sequencer or the synchronizers in a wide variety of manners that are determined to appropriate to provide the desired engine output and the constraints may be arranged to vary with the load placed on the engine, the overall ratio of firings to skips, or any other factor that is appropriate for the control of a particular engine.

### D. Diesel Engine Overview

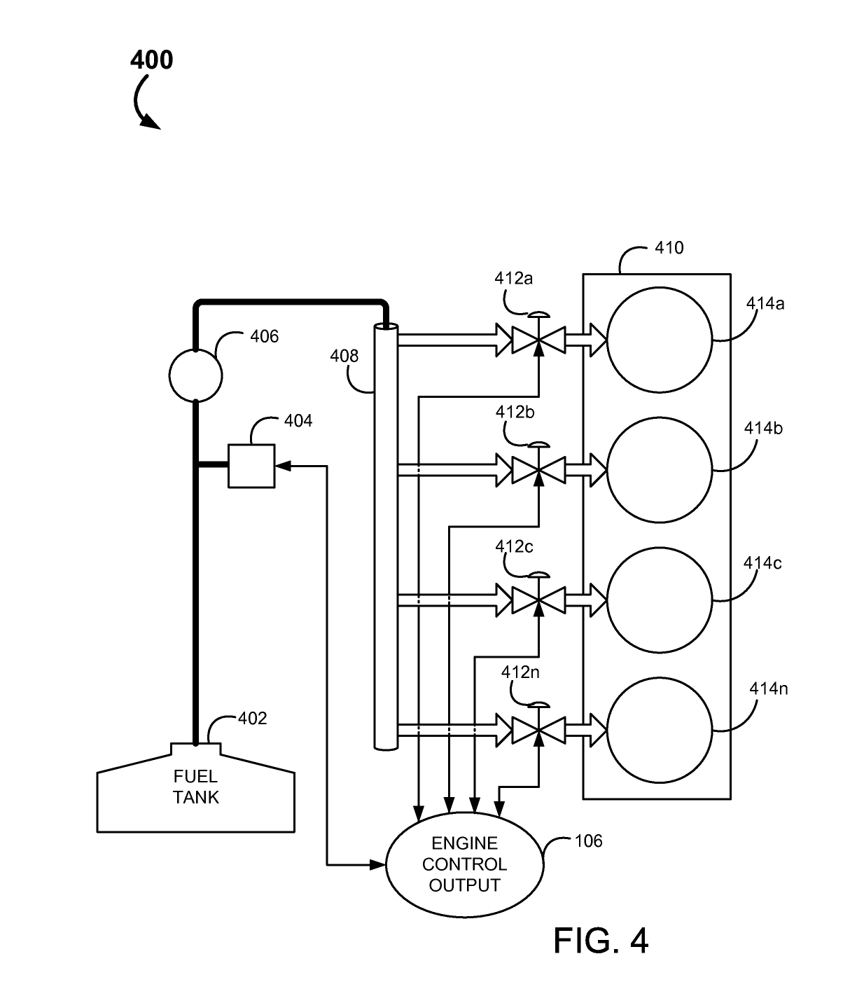

To help appreciate the benefits enhanced diesel control provides it is helpful to consider the typical workings of a diesel engine. FIG. 4 is an example structural diagram of a common rail diesel engine, shown generally at 400. The Engine Control Output 106 provided by the Improved Engine Control System 100A may be seen coupled to a fuel line Pressure Valve 404 and each Injector Valve 412a-412d. Additionally, pressure sensors from the feed line and the rail may be provided back to the ECU. Likewise, fuel temperature may be provided to the ECU.

Fuel from the Fuel Tank 402 may be pressurized (typically about 2000 psi) by one or more Pumps 406. The pressure may be regulated by the Pressure Valve 404. The pressurized fuel may be supplied to a common Rail 408. The individual injection Valves 412a-412d may open to allow fuel injection into each of the cylinders 414a-414d of the Engine 410.

As is well known in the art, the piston within the cylinders compresses the intake air, resulting in the air temperature rising. Fuel may then be injected at or near top dead center (TDC) whereby the fuel ignites due to the elevated air temperature. As previously noted, in modern engines fuel dispersion may be enhanced through common rail systems, multiple port injectors, group hole nozzle injectors and pulsed injection. In pulse injection a series of fuel pulses may be injected into the chamber before (primer) and at top dead center. Multiple pulses of fuel may enable more homogenous burn patterns. This method of engine operation is also useful in Homogenous Charge Combustion Ignition (HCCl) style engines. Some degree of recirculation of exhaust gas may also be desirable in some embodiments.

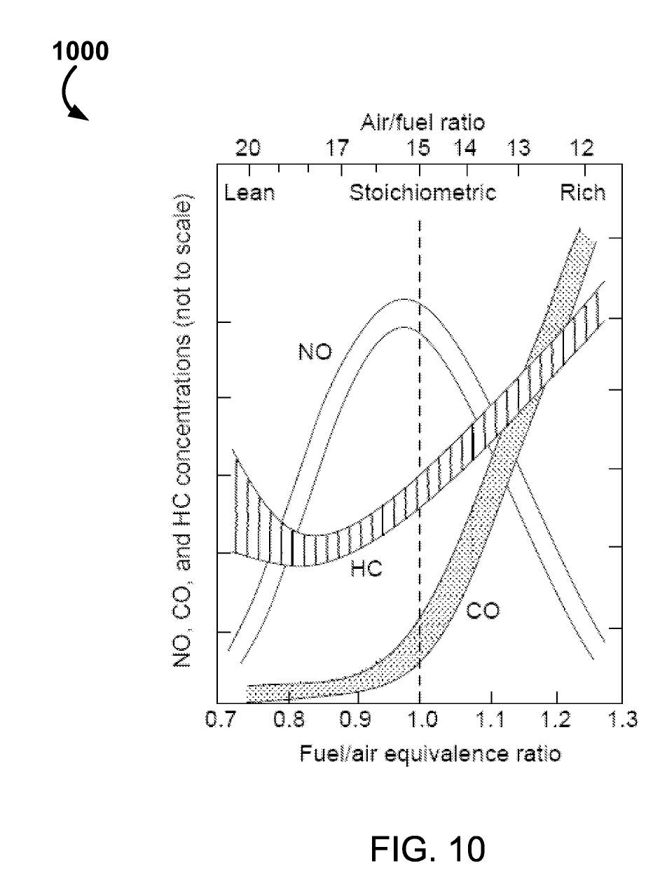

Turning briefly to FIG. 10, which illustrates selected emissions characteristics of a representative internal combustion engine at different air/fuel ratios. As can be seen therein, the amount of carbon monoxide (CO) in the emissions tends to increase as the mixture becomes richer and increases quite significantly in mixtures that are richer than stoichiometric. The amount of Nitric Oxide (NO) tends to be highest at a near stoichiometric mixture ratio and fall off relatively quickly as the air/fuel ratio becomes leaner or richer. The amount of hydrocarbons in the exhaust also generally tends to increase relatively quickly with increases in the mixture ratio beyond stoichiometric conditions. Many catalytic converters require the presence of a certain amount of carbon monoxide to run efficiently. If the engine runs lean, it is possible that the catalytic converter will become depleted and won't work efficiently due to the lack of carbon monoxide. As the optimal efficiency fuel to air ratio is relatively lean, elevated NOx may exist within the exhaust. This may lead to problems with state and federal emission control violations if the diesel exhaust is not treated NOx reducing system, such as BluTec or equivalent. Typically a urea solution is injected into the exhaust stream to release ammonium which then reduces the NOx to N₂.

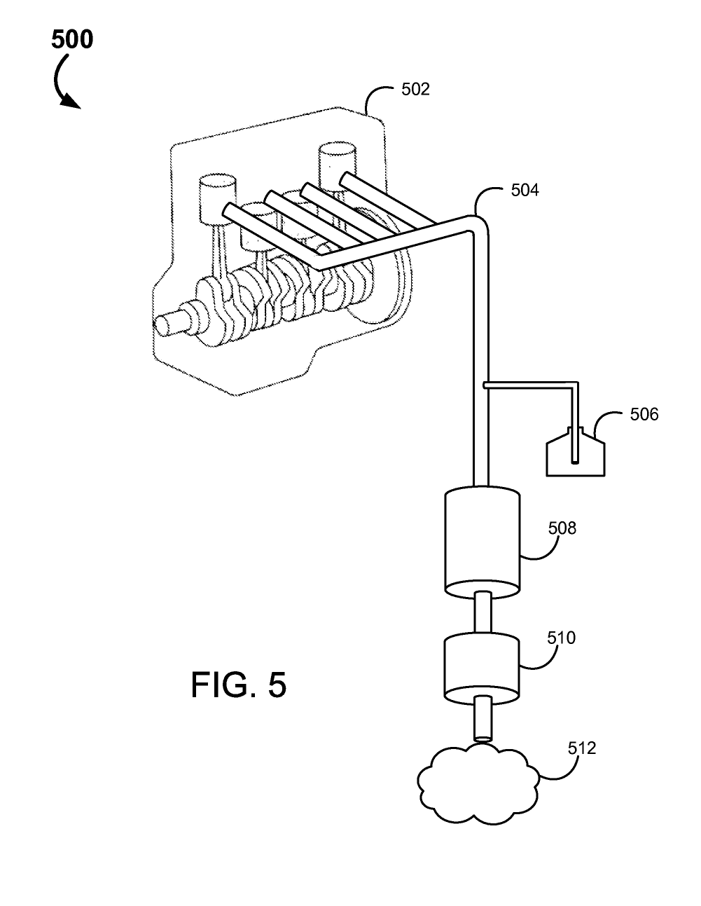

FIG. 5 provides an example structural diagram of a diesel engine exhaust system, shown generally at 500. This particular embodiment includes the presence of a urea Reservoir 506 for the reduction of NOₓ gasses. This type of exhaust system is increasingly being utilized on passenger vehicles in operation on the road today. Here the Engine 502 is shown coupled to an exhaust line 504. Urea, or another suitable reducer, may be contained in a Reservoir 506 for injection into the exhaust line prior to the Catalytic Converter 508. Excess oxygen gas may oxidize the CO and hydrocarbons of the exhaust in the Catalytic Converter 508. Likewise, the ammonia released from the urea may effectively reduce the NOₓ in the Catalytic Converter 508. The end result is the production of CO₂, N₂ and water.

The Catalytic Converter 508 may include a ceramic or other suitable substrate. The substrate may be honeycombed to increase effective surface area. Catalysts may be plated on the substrate to perform the necessary reactions. Typically platinum or palladium/rhodium may be utilized as catalysts, as is well known by those skilled in the art.

After the Catalytic Converter 508 excess soot may be trapped and eliminated by a Diesel Particulate Filter (DPF) 510. A number of substrates may be used for the DPF, including metal, paper, cordierite, and silicon carbide. Some DPFs are enabled to engage in regeneration by superficially raising temperature of exhaust periodically.

In some embodiments, it may be desirable for the Diesel Particulate Filter (DPF) 510 to be located upstream from the Catalytic Converter 508. Particularly, soot may enter the Catalytic Converter 508, resulting in buildup which renders the Catalytic Converter 508 inoperable. By locating the DPF 510 prior to the Catalytic Converter 508, soot may be removed before it can interfere with catalytic function. Likewise, some embodiments may include a combined particulate filter and catalytic converter.

The end result of the exhaust system is the exhaust Gas 512 which now conforms to EPA and other environmental regulations. The major components of exhaust gas include N₂, CO₂, O₂ and water.

### Ii. Methods for Improved Diesel Engine Control

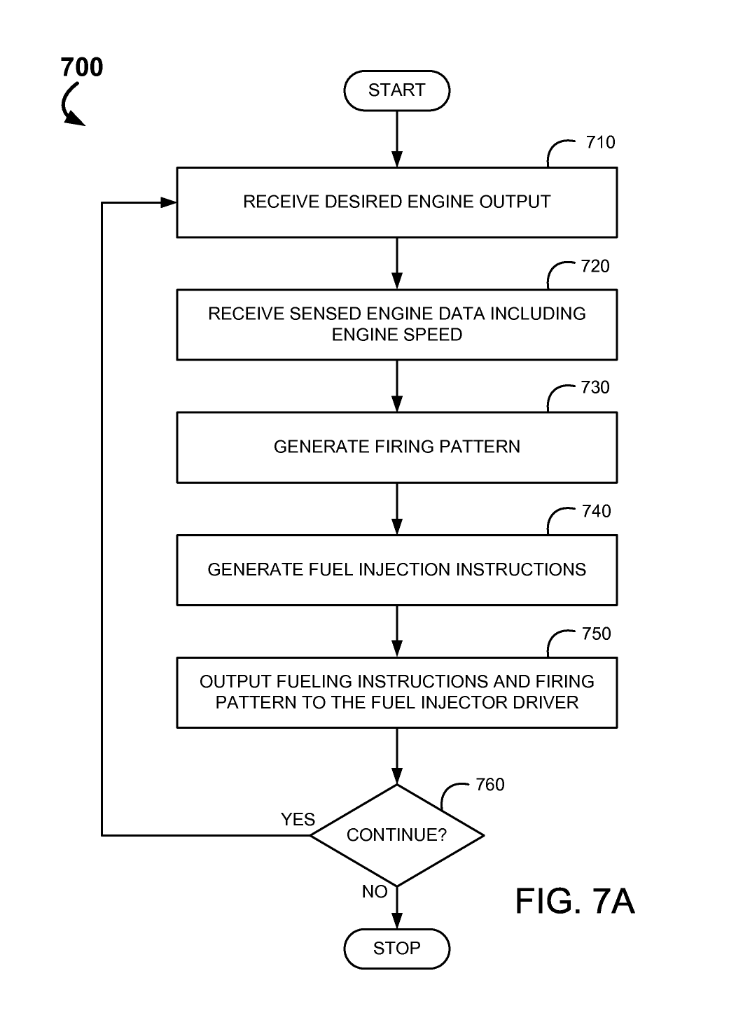

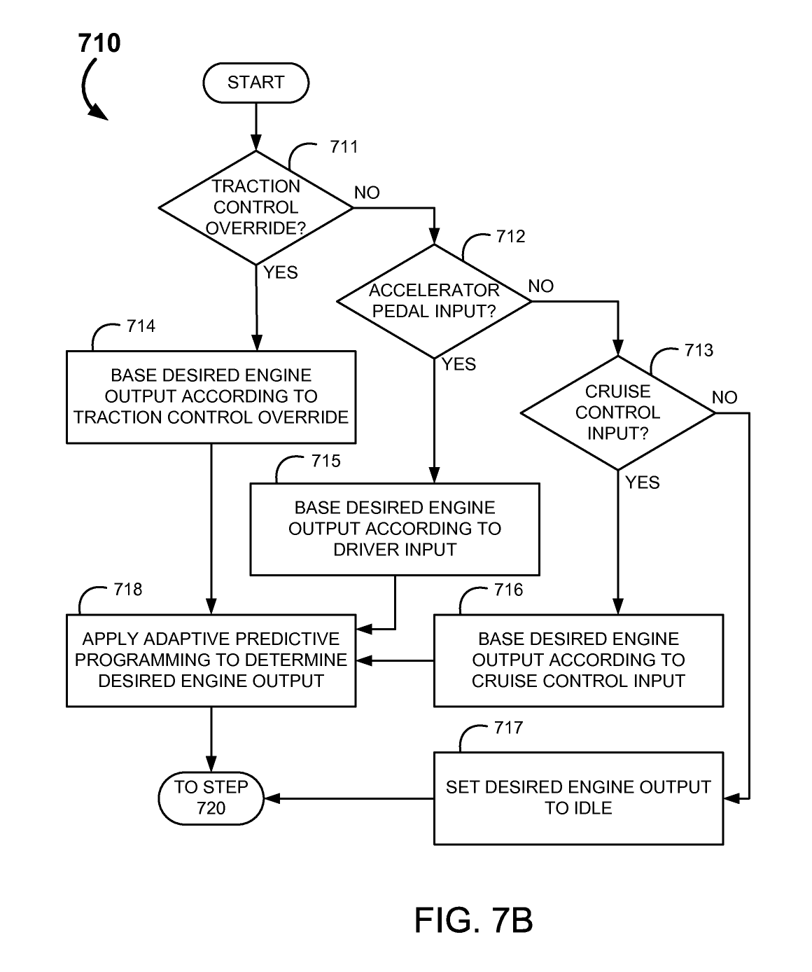

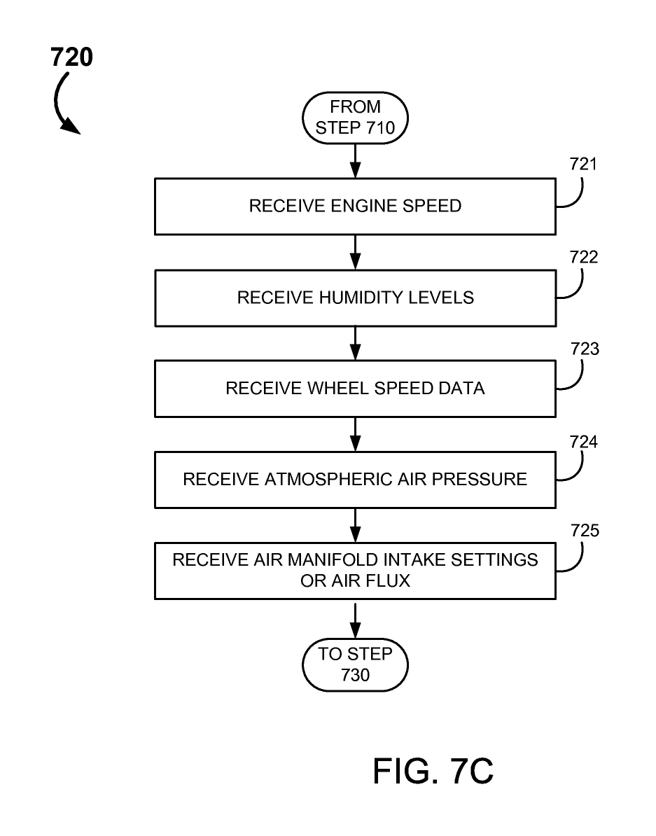

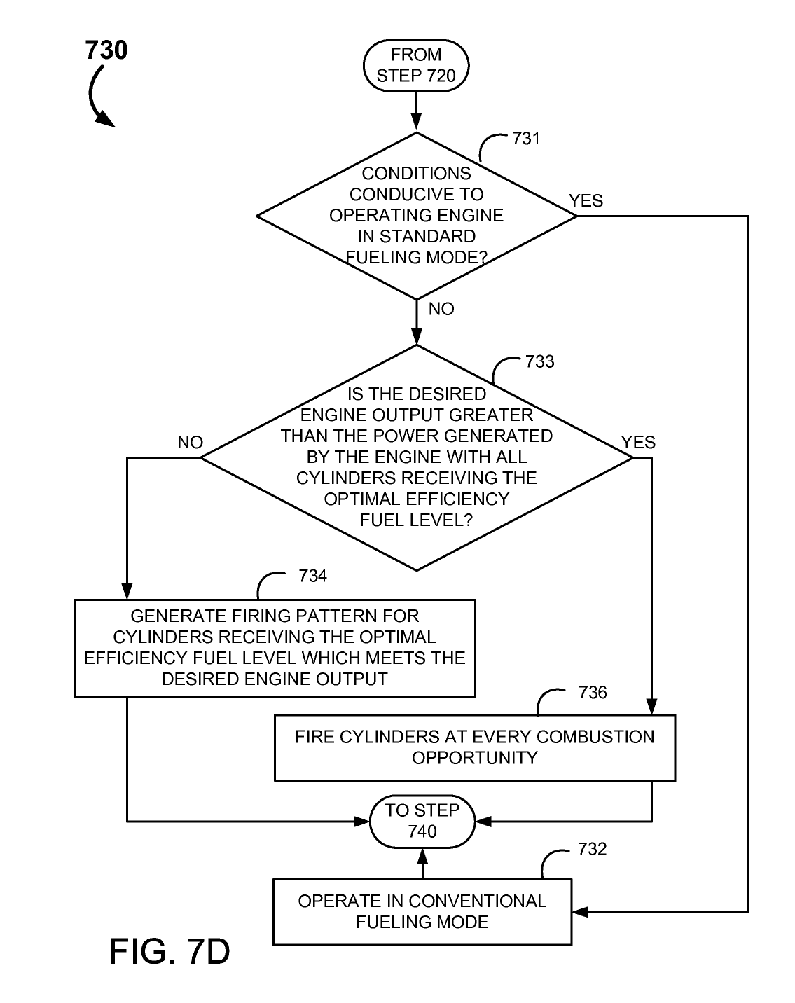

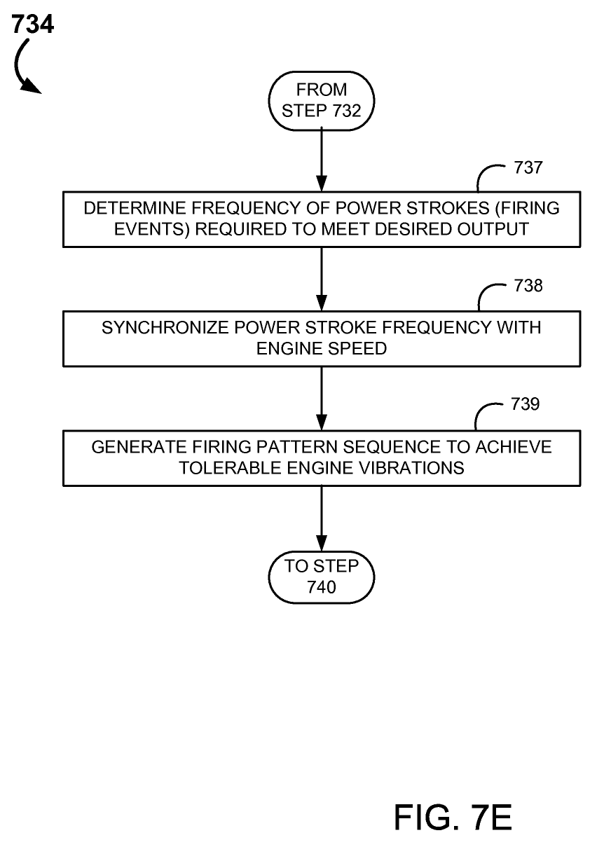

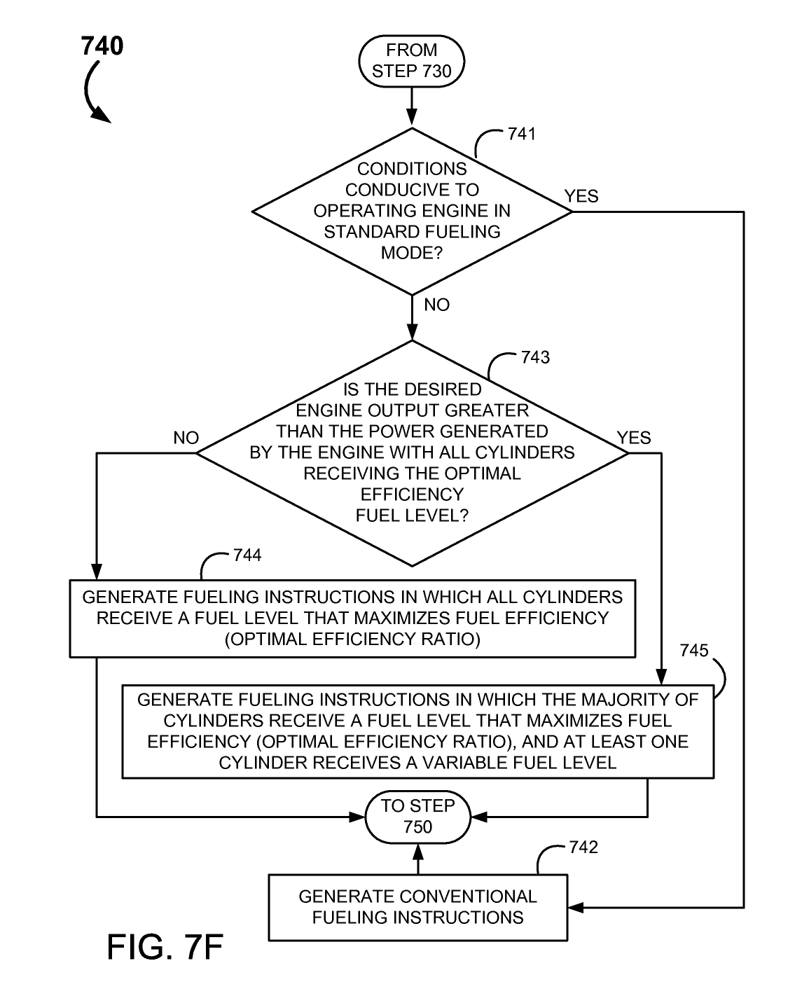

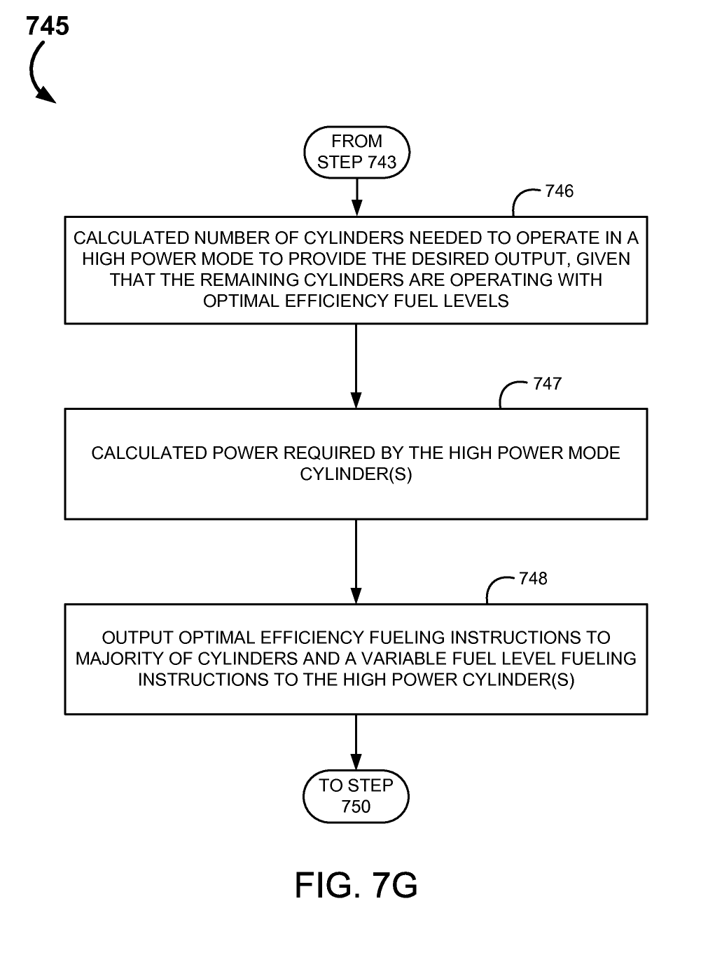

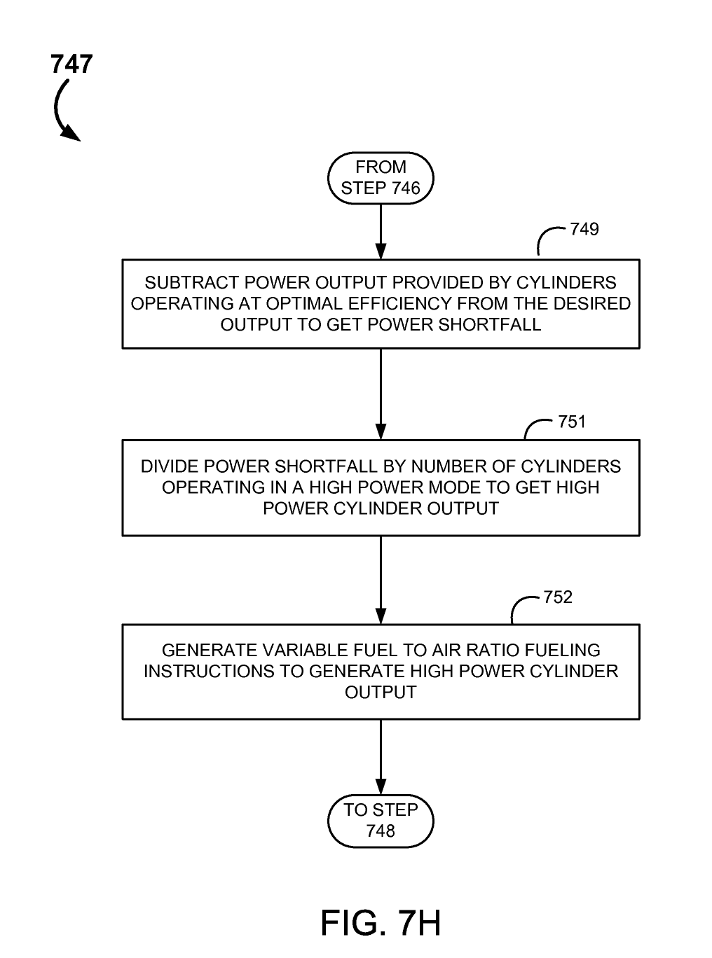

FIG. 7A is a flowchart diagram illustrating an example process for operating a compression ignition engine at high efficiency levels, shown generally at 700. The process begins at step 710 with the receipt of a desired engine output. Often the desired engine output takes the form of Driver Input 102. Other desired engine inputs are described below in more detail. Additionally, at step 720, sensed engine data may be received. Engine data, in this sense, includes operational conditions as well as ambient conditions. Other received engine data is described below in more detail.

After receipt of desired outputs and current conditions the system may generate firing patterns (step 730) and fueling instructions (step 740). In conventional and high power modes of operation the firing pattern is very simple as every cylinder fires at every combustion opportunity. Power is then modulated in these operational modes by varying fuel amounts delivered to cylinders. Conventional operational modes receive enough fuel for the instant combustion event to deliver the required output, while high power mode delivers optimal fuel levels to most of the cylinders and a larger amount of fuel to relatively few cylinders (high powered cylinders) to achieve the required output. When the engine is operating in relatively low-powered skip fire modes, the firing pattern will dictate when fuel is supplied to each cylinder in order to modulate power output. In this mode of operation, all cylinders receive optimal fuel amounts. By solving an optimization algorithm, as described above, the system may dynamically switch between conventional, skip fire and high power modes based upon instant power requirements. The effect of this is to reduce overall fuel consumption through more efficient engine operation. It is expected that engines operating in this manner will realize roughly 15% to 20% fuel efficiency gains. Of course, engine type, driving conditions and the like may dramatically affect the realized efficiency gains as a practical matter.

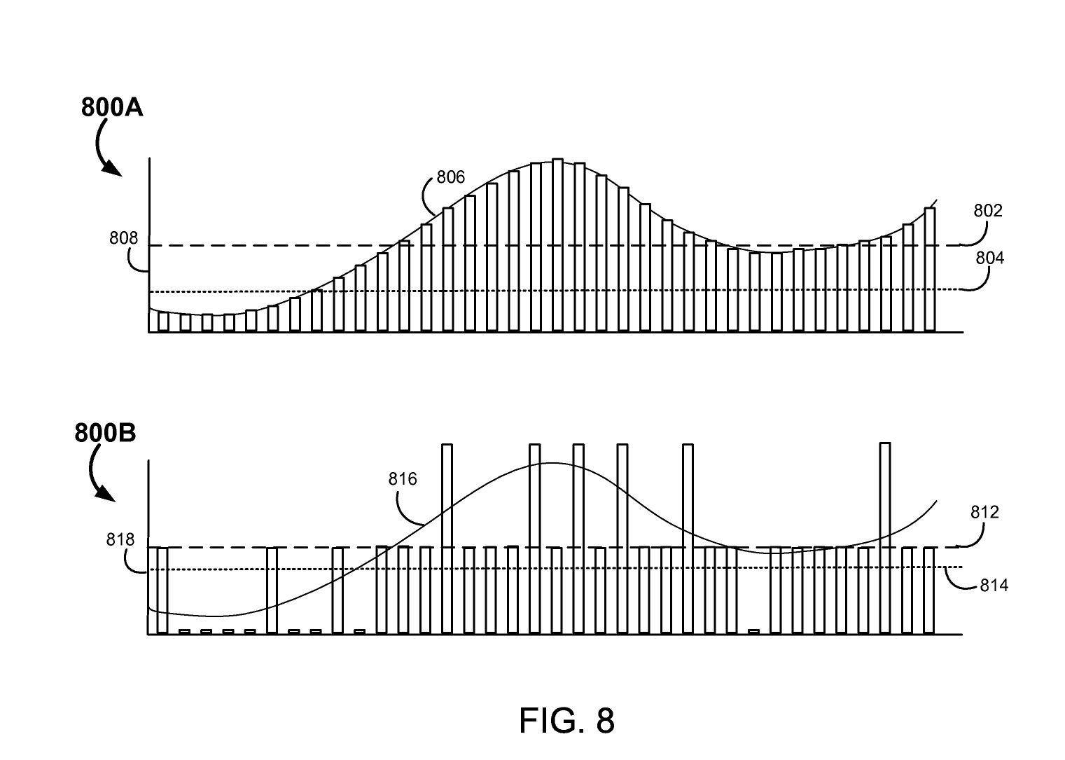

Looking briefly to FIG. 8, the efficiency of conventional operation and high efficiency operation are compared over an example set of working cycles. The combustion events for conventional operation are listed in the top graph labeled 800A. High efficiency operational mode is illustrated on the lower graph, labeled 800B. The amount of fuel injected into the cylinder varies to produce power, which is illustrated as the vertical bars on each graph (not to scale). The Y-axis 808 and 818 indicate amplitude of power. The produced power output 806 and 816 are identical between the two graphs. The power level providing the optimal fuel efficiency is labeled at 802 and 812. Lastly, the average fuel efficiency for each modes of operation is labeled at 804 and 814, respectively for conventional operation and high efficiency operation. Note that the efficiency for graph 800B is higher than that of graph 800A.

In a conventional mode of operation, every combustion opportunity is utilized. The produced power output 806 thus conforms to the instant power generated by each cylinder. In contrast, the high efficiency operation utilizes both skip fire and high power modes to increase overall efficiency, yet maintain a similar average power output 816. Skip fire mode may be most readily seen in the early combustion cycles. Relatively few cylinders are fired at optimal efficiency to achieve the required average power output. At higher power requirements, however, the example illustrates where the cylinders start receiving high powered fuel injections. Again, cylinders not receiving these higher fueling amounts are maintained at optimal efficiency fueling rates.

Returning to FIG. 7A, after firing patterns and fueling instructions are generated, the process continues to step 750 where the generated instructions are outputted to the fuel injector driver for implementation. An inquiry is made whether to end the operation at 760. If continuation is desired, the process returns to step 710 where an update of the desired engine output is received. In this way the system is capable of dynamic response to changes in operational conditions and power requirements as needed.

FIG. 7B is a flowchart diagram illustrating an example process for receiving the desired engine output when operating a compression ignition engine at high efficiency levels, shown generally at 710. This sub-process begins by querying, at step 711, if a traction control signal or other similar override signal is being received. Many modern vehicles include sensory data which can predict loss of control or imminent collisions. These sensory inputs may then be utilized by traction control or other safety systems to mitigate collision damage or maintain driver control of the vehicle. These systems may interface braking systems, suspension, and engine power. If such engine control override is sensed, the process will progress to step 714 where the desired engine output is based according to the traction control override.

Else, if there is no such override signal received at step 711, the process progresses to step 712 where an inquiry is made whether an input is received from the accelerator pedal. This would result from direct driver input. If the accelerator pedal is depressed, the desired engine output is based according to the accelerator pedal position at step 715.

Otherwise, if there is no indication that the accelerator pedal is being depressed at step 712, the process progresses to step 713 where an inquiry is made whether an input is received from the cruise control. If a cruise control signal is received, the desired engine output is based according to the cruise control input at step 716.

Lastly, if no cruise control signal is sensed at step 713, the desired engine output may be set to an idle at step 717.

Any signal received from the traction control, accelerator position or cruise control may be pre-processed in some embodiments of the invention. Preprocessing may include addition of dither to the signal, filtering or anti-aliasing. Additional preprocessing may also be preformed as is appropriate and desired for any given application.

Adaptive predictive programming may be utilized, at step 718, to determine the desired engine output. As discussed above, this output determination may be based upon any of traction control, accelerator pedal position or cruise control input. After the desired engine output is determined, the process ends by progressing to step 720 of FIG. 7A.

FIG. 7C is a flowchart diagram illustrating an example process for receiving the engine information from engine sensors when operating a compression ignition engine at high efficiency levels, shown generally at 720. The process begins from step 710 of FIG. 7A. Then, at step 721 engine speed is received. Engine speed may be received from tachometer or other suitable method. Then, at step 722, humidity levels may be received.

At step 723 wheel speed data may be collected by odometer readings or other suitable methods. Likewise, atmospheric air pressure may be sensed at step 724. The speed/flux of air into the air intake manifold may also be received at step 725.

In some embodiments, more or fewer measurements may be made, as is required or desired to operate the system. In some embodiments, it is foreseeable that only engine speed is collected for feedback purposes. In other embodiments, both engine speed and wheel speed are collected. The more engine sensory data collected, however, the richer the data set for computation of the fueling instructions. Thus, for sophisticated vehicles, all of these listed sensory data may be compiled in addition to other sensory data such as engine temperature, ambient temperature, fuel caloric quality, and such.

Some of the sensed data relates to the required feedback, and other data may be utilized to aid in the predictive control. After receiving engine sensory data the process ends by progressing to step 730 of FIG. 7A.

FIG. 7D is a flowchart diagram illustrating an example process for generation of a firing pattern for the desired engine output when operating a compression ignition engine at high efficiency levels, shown generally at 730. The process begins from step 720 of FIG. 7A. The process starts at step 731 by inquiring whether conditions are conducive to operating the engine in conventional fueling mode. Conventional operational modes may be appropriate for operation at very low power requirements where a skip fire operation might generate undesirable vibrations due to relatively slow engine rotational speed. Likewise, at very high power output requirements, there may be little difference between the fuel efficiency of high power mode of operation and conventional modes of operation. The decision of whether to run in conventional operational modes may be solved through an optimization problem. As previously discussed, determination of operational modes may be determined through the maximization of an efficiency model. Such an optimization may be solved for by methods known to those skilled in the art, including derivative tests, bundle methods, gradient descent, simplex methods, interior point methods, or any other known maximization technique. These optimizations may be solved by the system in real time or may be pre-solved and stored within a modality map. Thus, given a set of conditions including engine speed, desired power output and engine specifications, the system may simply look up the operational mode which maximizes fuel efficiency.

Likewise, a wide variety of triggers may be used to determine when it is appropriate to shift between operational modes. For example, an engine control system described herein may be arranged to operate in a conventional mode for a fixed period after every start, or until the engine reaches a desired operating temperature. Similarly, the engine control unit may be arranged to operate in a conventional mode any time the engine is operating at speeds outside a prescribed range, e.g., the engine is idling or otherwise operating at less than a threshold engine speed (e.g. 900 RPM). In other examples, the trigger thresholds for entering and exiting the variable displacement mode may be different. For example, it may be desirable to provide a first threshold (e.g. operating at over 1200 RPM) to trigger entering into the variable displacement mode and to provide a second threshold (e.g. operating at less than 900 RPM) for exiting the variable displacement mode. The staggering of the thresholds helps reduce the probability of frequent transitions in and out of different operating modes. Likewise, in yet other embodiments, vibration sensors may cause the engine to drop out of variable displacement modes when undesired engine vibrations are detected.

It should be appreciated that these are just examples of situations where it may be desirable to opt out of the continuously variable displacement mode with cylinders operating at optimal efficiency levels, and that there may be a wide variety of other situations that might warrant disengagement and/or triggers that may be used to initiate disengagement. The described situations and triggers are simply examples which may be used individually, in any desired combination, or not at all. Various embodiments of engine control units, firing control units, fuel co-processors and other arrangements that incorporate the described skip fire and high powered operating modes may be arranged to return to conventional operation whenever deemed appropriate and/or whenever operation in either of the efficiency modes is deemed inappropriate.

If, at step 731, it is determined that the engine is to run in a conventional operation mode the process progresses to step 732 where the engine is run in conventional fueling modes. In this case the fuel processor 110 may be entirely bypassed and the existing ECU may control fueling instructions. The sub-process then ends by returning to step 740 of FIG. 7A.

Else, if at step 731 it is determined that the engine is not to run in a conventional operation mode the process progresses to step 733 where another query is made as to whether the desired engine output is greater than the power outputted by the engine with all cylinders being fueled at their optimal fuel to air efficiency ratio. Again, the fuel to air efficiency ratio may vary depending on conditions and engine design; however, generally a diesel engine is most efficient at roughly 10% to 20% of the power rating of the engine. This ratio is considered very “lean” as there is much more air than fuel (less fuel than stoichiometric levels). Theoretically, complete burns at stoichiometry should have the best thermodynamic efficiency; however, given practical constraints of fuel mixing, friction and completeness of the combustion event it instead turns out that a very lean fuel to air ratio results in greater efficiency in the bulk of compression ignition engines. Thus, it may be desirable for engines to include any of multiple port injectors, grouped hole injector nozzles (GHN), common rail injectors, premixing chambers or other fuel dispersion enhancing system in order to more fully mix fuel within the chamber and aid in the complete combustion of all fuel. However, even including such systems, empirically, the diesel engine operates at peak efficiency in a relatively lean air to fuel ratio.

If the desired power output is above the power available with all cylinders running at optimal efficiency then the process progresses to step 736 where cylinders are fired at every combustion cycle in a high power operational mode. In this mode of operation the majority of cylinders typically run at an optimal efficiency levels and one or more cylinders may engage in an increased duty cycle by receiving greater amounts of fuel. In some embodiments, the increased duty cycle may be a percentage of stoichiometric fueling, as there is little further power provided if additional fuel is injected above stoichiometric levels. The exact increase in fueling amounts and the number of cylinders receiving the increased fuel may be determined by the efficiency algorithm which is optimized, as discussed above. Further, a multi-bit output from the Drive Pulse Generator 214 may be utilized to determine mode of operation and fueling levels. This sub-process then ends by returning to step 740 of FIG. 7A.

Otherwise, if at step 733 the desired power output is below the power available with all cylinders running at optimal efficiency then the process progresses to step 734 where a firing pattern is generated for the fueling of the cylinders where the optimal fuel to air ratio is provided to the cylinders when they are fueled. This is a skip fire mode of operation. The sub-process then ends by returning to step 740 of FIG. 7A.

As diesel engines rely upon compression heat and fuel injection to begin ignition, not fueling a particular cylinder results in a “skip fire” or non-combustion event. Not fueling the cylinder, in conjunction with keeping exhaust and intake valves closed, effectively “shuts down” or deactivates a cylinder. Thus, the cylinder behaves as an air spring, thereby providing no power to the engine. The trapped exhaust gases (kept from the previous charge burn) are compressed during the piston's upstroke and push down on the piston during its down stroke. The compression and decompression of the trapped exhaust gases have an equalizing effect, thus, overall, there is virtually no extra load on the engine. Thus, even though some of the cylinders in the engine are running at a highly efficient level, on average power output of the engine may be controlled with a fine level of granularity.

Of note is that there are many known techniques for disabling a cylinder. For example, for pushrod designs, when cylinder deactivation is called for, hydraulic valve lifters are collapsed by using solenoids to alter the oil pressure delivered to the lifters. In their collapsed state, the lifters are unable to elevate their companion pushrods under the valve rocker arms, resulting in valves that cannot be actuated and remain closed. Likewise, for overhead cam designs, generally a pair of locked-together rocker arms is employed for each valve. One rocker follows the cam profile while the other actuates the valve. When a cylinder is deactivated, solenoid controlled oil pressure releases a locking pin between the two rocker arms. While one arm still follows the camshaft, the unlocked arm remains motionless and unable to activate the valve. The present invention is versatile enough to utilize any of the foregoing, as well as another known or future known mechanism for deactivating cylinders.

FIG. 7E is a flowchart diagram illustrating an example process for generating a skip fire pattern at optimal efficiency when operating a compression ignition engine at high efficiency levels, shown generally at 734. This sub-process begins from step 732 of FIG. 7D. Then, at step 737, the frequency of cylinder combustion events is determined to meet the desired output. This may be generated through any of the above disclosed methods; however, the Drive Pulse Generator 214 including a sigma delta control circuit is particularly adapted to the generation of the frequency and timing of these firing events.

Logically, the desired power may be divided by the power supplied by a single cylinder operating at peak efficiency levels. This calculation generates the number of combustion events over a given period of time required to generate the desired power output. Air humidity, fuel temperature, fuel calorie content and additional factors may all be considered during this calculation.

If the calculated number of combustion events in a given time period is a non integer value, then the needed power output cannot be achieved by combustion events at optimal fuel to air ratio values. In order to still meet the desire power levels, and still run at optimal efficiency fuel to air ratio, the engine may be run with a particular number of combustion events during some working cycles and more during other working cycles such that the average engine power is the same as desired power output. The ratio between the lower number of combustion events in some cycles and the higher number in other cycles may be determined from the decimal portion of the calculated number of cylinders needed.

For example, suppose the accelerator position indicates a desired output of 30 horsepower (hp) and the output of a V6 diesel engine rated at 480 hp. Also assume that, at optimal efficiency fuel to air ratio output, each cylinder is contributing equally to the total engine output and provides 10 hp. Thus, the necessary number of cylinders would be 30 hp/10 hp=3 (desired output/output per cylinder). Thus, in this simplified example, 3 cylinders would be set as operational per combustion cycle.

Continuing the example, suppose the driver of the vehicle depresses the pedal further as she attempts to pass another vehicle. Now the desired output rises to 35 hp. The resulting raw cylinder number rises to 3.5. The system may then run at 3 cylinders (rounded down) at optimal efficiency fuel to air ratio conditions for some combustion cycles, and at 4 cylinders (rounded up) for other combustion cycles. Thus, some cycles may produce 30 hp, and other cycles 40 hp may be produced. Thus, when the ratio of 3 cylinder operation is equal to 4 cylinder operation the average output is 35 hp for this simplified example. Due to the relative short duration of engine combustion cycles (at 3000 rpm there is a cycle every 0.02 seconds) any fluctuations in engine power output dependent upon cycle may be virtually unperceivable.

Thus, in some embodiments the number of cylinders in operation per engine combustion cycle may be alternating per cycle, such as: 3, 4, 3, 4, 3, . . . 4. Alternatively, it may be every other cycle, such as: 3, 3, 4, 4, 3, 3, . . . 4, 4. Of course other cylinder number per cycle patters may be utilized a long as the ratio of cylinders fired provides an average output equal to the desired output.

Again, referring back to the previous example, assume that after passing the other car, the driver is traveling at an increased speed but is no longer accelerating for a pass, thus the driver is able to slightly reduce the power required to, say 32.5 hp. Now the raw cylinder number is 3.25. In the same embodiment described above, the system may still use 3 cylinders at some engine cycles and 4 cylinders at other cycles. However, as the desired output is lower than before, the ratio of 3 cylinder operation may be higher than the operation in 4 cylinders. In fact, to provide the proper average power output a three to one ratio would be appropriate, such as 3, 3, 3, 4, 3, 3, 3, 4, . . . 3. Of course other cylinder number per cycle patterns may be utilized a long as the ratio of cylinders fired provides an average output equal to the desired output.

As noted earlier, these examples ignore many of the nuances of engine function for the sake of simplicity. For example, each cylinder may produce different power outputs, or power output per cylinder may range dependent upon engine and environmental factors (such as engine speed and elevation). The present invention is robust enough to detect these complexities of engine function in determining the number and ratio of cylinders which are to be utilized.

Then, at step 738, the Synchronizer 216 synchronizes the output of the Drive Pulse Generator 214 with actual engine speed. This results in the generation of a firing pattern sequence, at step 739. In some embodiments, order of cylinder firing may also be taken into account in the generation of this sequence to minimize unwanted engine vibrations. The sub-process then ends by returning to step 740 of FIG. 7A.

FIG. 7F is a flowchart diagram illustrating an example process for generating fueling instructions when operating a compression ignition engine at high efficiency levels, shown generally at 740. The process begins from step 730 of FIG. 7A. The process starts at step 741 by inquiring whether conditions are conducive to operating the engine in conventional fueling mode. As previously discussed, selection of operational modes may be determined through the maximization of an efficiency model.

If, at step 741, it is determined that the engine is to run in a conventional operation mode the process progresses to step 742 where the engine is run in conventional fueling modes. In this case the fuel processor 110 may be entirely bypassed and the existing ECU may control fueling instructions. The sub-process then ends by returning to step 750 of FIG. 7A.

Else, if at step 741 it is determined that the engine is not to run in a conventional operation mode the process progresses to step 743 where another query is made as to whether the desired engine output is greater than the power outputted by the engine with all cylinders being fueled at their optimal fuel to air efficiency ratio.

If the desired power output is above the power available with all cylinders being fueled at their optimal fuel to air efficiency ratio, then fueling instructions are generated where the majority of cylinders receive optimal fuel to air ratios and the remaining high powered cylinders receive a larger injection of fuel as to provide the needed power output, at step 745. As stated earlier, a multi-bit firing sequence may be provided from the Fuel Processor 110. Additionally, the firing pulse may include variable amplitudes to indicate different levels of fueling. Thus, control of fueling levels of the high powered cylinders may be dictated by the output of the fuel processor. The sub-process then ends by returning to step 750 of FIG. 7A.

If the desired power output is below the power available with all cylinders being fueled at their optimal fuel to air efficiency ratio then fueling instructions are generated, at step 744, where every cylinder receives the optimal fuel to air ratio when they are fueled. Thus, all cylinders are operating at peak efficiency during skip fire operation. The sub-process then ends by returning to step 750 of FIG. 7A.

FIG. 7G is a flowchart diagram illustrating an example process for generating fueling instructions for high power mode operation, shown generally at 745. The process begins from step 743 of FIG. 7F. The process starts at step 746 where the number of cylinders needed to operate in a high power mode is calculated. This may occur in real time as needs demand, or may be pre-calculated and stored within a lookup data set. Likewise, at step 747, the power required from the high powered cylinders is calculated. Again this calculation may be based upon real time calculations or stored pre-modeled data. Lastly, at step 748, the cylinder numbers and fueling levels may be output to the fuel injector driver for implementation. The sub-process then ends by returning to step 750 of FIG. 7A.

FIG. 7H is a flowchart diagram illustrating an example process for determining the power output for the high powered cylinders for high power mode operation, shown generally at 747. The process begins from step 746 of FIG. 7G. The process starts at step 749 where the output provided by the cylinders operating at optimal efficiency fuel to air ratio is subtracted from the desired output. This results in a power ‘short fall’ which the high powered cylinders must compensate for. The shortfall may be divided by the number of high powered cylinders to determine the power these cylinders must produce individually, at step 751. Lastly, at step 752, the system determines the variable fuel to air ratio required to produce the needed power in the overpowered cylinders. Fueling instructions are then generated for these cylinders using the determined fuel to air ratio. The sub-process then ends by returning to step 748 of FIG. 7G.

Of course, other logical and mathematical methods may be utilized to determine the number of cylinders operating in high powered mode, and the power they must generate given a desired output. In situations where the system utilizes a lookup dataset, these values may be modeled empirically for each engine model. Alternatively, mathematical models may be utilized.

One possible example of a mathematical method for determining the number of cylinders needed to operate in high powered modes, and power requirements of the high powered cylinders is to solve for the following set of equations:

DesiredOutput=ΣPₒCₒ+PᵢCᵢ (Equation 1.1)

TotalCylinders=Cₒ+Cᵢ (Equation 1.2)

FuelConsumption=ΣFₒCₒ+FᵢCᵢ (Equation 1.3)

Fᵢ=k(P) (Equation 1.4)

Fᵢ=k(Pᵢ) (Equation 1.5)

Solve Min(Fuel Consumption) (Equation 1.6)

where:

Pₒ=power provided by each cylinder at optimal fuel to air ratio;

Cₒ=number of cylinders operating at optimal fuel to air ratio;

Pᵢ=power provided by each cylinder at high powered fuel to air ratio;

Cᵢ=number of cylinders operating at high powered fuel to air ratio;

Fₒ=fuel used by each cylinder operating at optimal fuel to air ratio; and

Fᵢ=fuel used by each cylinder operating at high powered fuel to air ratio.

In the above equation set the ‘TotalCylinders’ is a known value corresponding to the number of cylinders in the engine. Likewise, the ‘DesiredOutput’ is a known value. The fuel consumption functions ‘k(x)’ may be pre-modeled for a particular engine type given known loads. The fuel consumption values are nonlinear with fuel consumption increasing exponentially to power after stoichiometry. Optimal fuel to air ratios are also known for the engine, therefore optimal power (Pₒ) is know. Thus, as fuel use (F) is dependent upon power output (P) the entire set of equations may be condensed and solved for the remaining unknown variables: Cₒ, Cᵢ and Pᵢ. Note that this is an example equation set and has been suitably simplified to assist in the understanding of the principles of the invention. In practice, other equations may be provided or substituted which account for additional data including engine speed, ambient conditions, engine conditions, and multiple power levels for different cylinders.

In sum, systems and methods for improving control over diesel engines for increased fuel efficiency are provided. While a number of specific examples have been provided to aid in the explanation of the present invention, it is intended that the given examples expand, rather than limit the scope of the invention. Although sub-section titles have been provided to aid in the description of the invention, these titles are merely illustrative and are not intended to limit the scope of the present invention.

While the system and methods has been described in functional terms, embodiments of the present invention may include entirely hardware, entirely software or some combination of the two. Additionally, manual performance of any portion of the methods disclosed is considered by the present invention.

While this invention has been described in terms of several preferred embodiments, there are alterations, permutations, modifications and various substitute equivalents, which fall within the scope of this invention. It should also be noted that there are many alternative ways of implementing the methods and systems of the present invention. It is therefore intended that the following appended claims be interpreted as including all such alterations, permutations, modifications, and various substitute equivalents as fall within the true spirit and scope of the present invention.

What is claimed is:

1. A method for improving efficiency of a compression ignition internal combustion engine having a plurality of cylinders capable of operating in a succession of combustion cycles by generating a non-uniform fueling profile to generate fueling efficiency gains, the method comprising:
receiving a request for a first desired engine output;
generating fuel injection instructions to generate the non-uniform fueling profile across the plurality of cylinders which will produce a power output from the compression ignition internal combustion engine which substantially conforms to the first desired engine output, wherein said generating step comprises:
substantially controlling the regulation of fuel flow to at least one of the plurality of cylinders at a substantially optimal efficiency fuel level during each of their respective working cycles, wherein the regulation of fuel flow to the at least one of the plurality of cylinders is determined by the generated fuel injection instructions, and wherein the optimal efficiency fuel level is determined from the ratio of fuel injected into the at least one cylinder to the air drawn into the at least one cylinder which substantially maximizes fuel efficiency; and
substantially controlling the regulation of fuel flow to at least one of the other of the plurality of cylinders at a higher fuel level, wherein the number of cylinders receiving the higher fuel level is dynamically determined to provide the first desired output for the engine.

2. The method for improving the efficiency of the compression ignition internal combustion engine, as recited in claim 1, further comprising:
receiving an updated request for a second desired engine output; and
substantially controlling the regulation of fuel flow to at least one of the plurality of cylinders at a second higher fuel level, wherein the second higher fuel level is dynamically determined to provide the second desired output for the engine.

3. The method for improving the efficiency of the compression ignition internal combustion engine, as recited in claim 1, further comprising:
determining a maximum number of the plurality of cylinders that can be operated all of the time at the optimal efficiency fuel level without exceeding the first desired output;
substantially controlling the regulation of fuel delivery to a first subset of cylinders of the plurality of cylinders at optimal efficiency fuel level during at least one of their respective working cycles, wherein the first subset of cylinders is limited to the maximum number of cylinders; and
substantially disabling fuel injection into a second subset of cylinders of the plurality of cylinders during at least one of their respective working cycles, wherein the first subset of cylinders plus the second subset of cylinders equals the plurality of cylinders.

4. The method for improving the efficiency of the compression ignition internal combustion engine, as recited in claim 3, further comprising receiving at least one current operating condition including at least one of engine speed, wheel speed, air intake manifold flux, slope the vehicle is on, and movement resistance.

5. The method for improving the efficiency of the compression ignition internal combustion engine, as recited in claim 4, wherein determining the maximum number of the plurality of cylinders that can be operated all of the time at the optimal efficiency fuel level without exceeding the first desired output includes referencing the at least one current operating condition.

6. The method for improving the efficiency of the compression ignition internal combustion engine, as recited in claim 4, further comprising synchronizing firing of the plurality of cylinders during their working cycles with the engine speed.

7. The method for improving the efficiency of the compression ignition internal combustion engine, as recited in claim 3, further comprising monitoring the desired output and adaptively changing the number of cylinders in operation and adaptively varying the fueling of the at least one of the first subset of cylinders in order to deliver the desired output in accordance with variations in the desired output.

8. The method for improving the efficiency of the compression ignition internal combustion engine, as recited in claim 1, wherein the compression ignition internal combustion engine is a diesel engine.

9. The method for improving the efficiency of the compression ignition internal combustion engine, as recited in claim 1, wherein the compression ignition internal combustion engine is a homogenous charge compression ignition engine.

10. The method for improving the efficiency of the compression ignition internal combustion engine, as recited in claim 1, wherein the first desired engine output may be determined using adaptive predictive control circuitry.

11. The method for improving the efficiency of the compression ignition internal combustion engine, as recited in claim 10, wherein a sigma delta controller is used in the generation of the fuel injection instructions.

12. The method for improving the efficiency of the compression ignition internal combustion engine, as recited in claim 10, wherein the predictive adaptive control circuitry is selected from the group consisting of: a pulse width modulation controller, a least means square controller and a recursive least square controller.

13. The method for improving the efficiency of the compression ignition internal combustion engine, as recited in claim 10, wherein the predictive adaptive control circuitry includes feedback indicative of at least one of requested and actual working cycle firings.

14. The method for improving the efficiency of the compression ignition internal combustion engine, as recited in claim 13, wherein the generation of the fuel injection instructions is determined at least in part using predictive adaptive feedback control to provide the first desired engine output.

15. The method for improving the efficiency of the compression ignition internal combustion engine, as recited in claim 1, wherein air intake to the plurality of cylinders is constant over the succession of combustion cycles.

16. The method for improving the efficiency of the compression ignition internal combustion engine, as recited in claim 15, wherein fuel injection into each of the at least one of the plurality of cylinders is modulated to achieve the substantially optimal fuel to air ratio.

17. The method for improving the efficiency of the compression ignition internal combustion engine, as recited in claim 15, wherein fuel injection into each of the at least one of the plurality of cylinders is modulated to achieve a first and second variable fuel to air ratio.

18. The method for improving the efficiency of the compression ignition internal combustion engine, as recited in claim 1, wherein the fuel injection instructions are dynamically calculated during operation of the engine on a working cycle by working cycle basis to provide the first desired engine output.

19. A system for improving efficiency of a compression ignition internal combustion engine having a plurality of cylinders capable of operating in a succession of combustion cycles by generating a non-uniform fueling profile to generate fueling efficiency gains, the system comprising:
a fuel processor configured to perform the steps of:
receiving a request for a first desired engine output;
generating fuel injection instructions to generate the non-uniform fueling profile across the plurality of cylinders which will produce a power output from the compression ignition internal combustion engine which substantially conforms to the first desired engine output, wherein said generating step comprises:
substantially controlling the regulation of fuel flow to at least one of the plurality of cylinders at a substantially optimal efficiency fuel level during each of their respective working cycles, wherein the regulation of fuel flow to the at least one of the plurality of cylinders is determined by the generated fuel injection instructions, and wherein the optimal efficiency fuel level is determined by the ratio of fuel injected into the at least one cylinder to air drawn into the at least one cylinder which substantially maximizes fuel efficiency; and
substantially controlling the regulation of fuel flow to at least one of the other of the plurality of cylinders at a higher fuel level, wherein the number of cylinders receiving the higher fuel level is dynamically determined to provide the first desired output for the engine.

20. The system for improving the efficiency of the compression ignition internal combustion engine, as recited in claim 19, wherein the fuel processor is further configured to:
receive an updated request for a second desired engine output; and
substantially regulate fuel flow to at least one of the plurality of cylinders at a second higher fuel level, wherein the second higher fuel level is dynamically determined to provide the second desired output for the engine.

21. The system for improving the efficiency of the compression ignition internal combustion engine, as recited in claim 19, wherein the fuel processor is further configured to:
determine a maximum number of the plurality of cylinders that can be operated all of the time at the optimal efficiency fuel level without exceeding the first desired output;
substantially regulate fuel delivery to a first subset of cylinders of the plurality of cylinders at optimal efficiency fuel level during at least one of their respective working cycles, wherein the first subset of cylinders is limited to the maximum number of cylinders; and
substantially disable fuel injection into a second subset cylinders of the plurality of cylinders during at least one of their respective working cycles, wherein the first subset of cylinders plus the second subset of cylinders equals the plurality of cylinders.

22. The system for improving the efficiency of the compression ignition internal combustion engine, as recited in claim 21, wherein the fuel processor receives at least one current operating condition including at least one of engine speed, wheel speed, air intake manifold flux, slope the vehicle is on, and movement resistance.

23. The system for improving the efficiency of the compression ignition internal combustion engine, as recited in claim 22, wherein determining the maximum number of the plurality of cylinders that can be operated all of the time at the optimal efficiency fuel level without exceeding the first desired output includes referencing the at least one current operating condition.

24. The system for improving the efficiency of the compression ignition internal combustion engine, as recited in claim 22, wherein the fuel processor includes a synchronizer configured to synchronize firing of the plurality of cylinders during their working cycles with the engine speed.

25. The system for improving the efficiency of the compression ignition internal combustion engine, as recited in claim 21, wherein the fuel processor includes a sigma delta control circuit configured to monitor the desired output and adaptively changing the number of cylinders in operation and adaptively varying the fueling of the at least one of the first subset of cylinders in order to deliver the desired output in accordance with variations in the desired output.

26. The system for improving the efficiency of the compression ignition internal combustion engine, as recited in claim 19, wherein the compression ignition internal combustion engine is a diesel engine.

27. The system for improving the efficiency of the compression ignition internal combustion engine, as recited in claim 19, wherein the compression ignition internal combustion engine is a homogenous charge compression ignition engine.

28. The system for improving the efficiency of the compression ignition internal combustion engine, as recited in claim 25, wherein the fuel processor comprises an adaptive predictive control circuitry adapted to determine the first desired engine output.

29. The system for improving the efficiency of the compression ignition internal combustion engine, as recited in claim 28, wherein the fuel processor comprises a sigma delta controller used in the generation of the fuel injection instructions.

30. The system for improving the efficiency of the compression ignition internal combustion engine, as recited in claim 28, wherein the predictive adaptive control circuitry is selected from the group consisting of: a pulse width modulation controller, a least means square controller and a recursive least square controller.

31. The system for improving the efficiency of the compression ignition internal combustion engine, as recited in claim 28, wherein the predictive adaptive control circuitry includes feedback indicative of at least one of requested and actual working cycle firings.

32. The system for improving the efficiency of the compression ignition internal combustion engine, as recited in claim 31, wherein the generation of the fuel injection instructions is determined at least in part using predictive adaptive feedback control to provide the first desired engine output.

33. The system for improving the efficiency of the compression ignition internal combustion engine, as recited in claim 19, wherein air intake to the plurality of cylinders is constant over the succession of combustion cycles.

34. The system for improving the efficiency of the compression ignition internal combustion engine, as recited in claim 33, wherein fuel injection into each of the at least one of the plurality of cylinders is modulated to achieve the substantially optimal fuel to air ratio.

35. The system for improving the efficiency of the compression ignition internal combustion engine, as recited in claim 33, wherein fuel injection into each of the at least one of the plurality of cylinders is modulated to achieve a first and second variable fuel to air ratio.

36. The system for improving the efficiency of the compression ignition internal combustion engine, as recited in claim 19, wherein the fuel injection instructions are dynamically calculated during operation of the engine on a working cycle by working cycle basis to provide the first desired engine output.

37. A method for improving efficiency of a compression ignition internal combustion engine having a plurality of cylinders capable of operating in a succession of combustion cycles by generating a non-uniform fueling profile to generate fueling efficiency gains, the method comprising:
receiving a request for a first desired engine output;
generating fuel injection instructions to generate the non-uniform fueling profile across the plurality of cylinders which will produce a power output from the compression ignition internal combustion engine which substantially conforms to the first desired engine output, wherein said generating step comprises:
substantially controlling the regulation of fuel flow to a first subset of the plurality of cylinders at a substantially optimal efficiency fuel level during at least one of their respective working cycles, wherein the regulation of fuel flow to the first subset of the plurality of cylinders is determined by the generated fuel injection instructions, and wherein the optimal efficiency fuel level is determined from the ratio of fuel injected into the at least one cylinder to air drawn into the at least one cylinder which substantially maximizes fuel efficiency; and
substantially disabling fuel injection into to a second subset of the plurality of cylinders while the compression ignition internal combustion engine is in a first operational state corresponding to the first desired engine output, wherein the ratio of cylinders in the first subset of cylinders and the second subset of cylinders corresponds to the generated fuel injection instructions, and wherein the first subset of cylinders plus the second subset of cylinders equals the plurality of cylinders.

38. The method for improving the efficiency of the compression ignition internal combustion engine, as recited in claim 37, further comprising:
receiving an updated request for a second desired engine output; and
substantially controlling the regulation of fuel flow to at least one of the other of the plurality of cylinders at a higher fuel level, wherein the higher fuel level is dynamically determined to provide the second desired output for the engine.

39. The method for improving the efficiency of the compression ignition internal combustion engine, as recited in claim 37, further comprising receiving at least one current operating condition including at least one of engine speed, wheel speed, air intake manifold flux, slope the vehicle is on, and movement resistance.

40. The method for improving the efficiency of the compression ignition internal combustion engine, as recited in claim 39, wherein the generating fuel injection instructions includes referencing the at least one current operating condition.

41. The method for improving the efficiency of the compression ignition internal combustion engine, as recited in claim 39, further comprising synchronizing firing of the plurality of cylinders during their working cycles with the engine speed.

42. The method for improving the efficiency of the compression ignition internal combustion engine, as recited in claim 37, further comprising:
monitoring the desired output and adaptively changing the number of cylinders in operation and adaptively varying the fueling of the at least one of the first subset of cylinders in order to deliver the desired output in accordance with variations in the desired output.

43. The method for improving the efficiency of the compression ignition internal combustion engine, as recited in claim 37, wherein the compression ignition internal combustion engine is a diesel engine.

44. The method for improving the efficiency of the compression ignition internal combustion engine, as recited in claim 37, wherein the compression ignition internal combustion engine is a homogenous charge compression ignition engine.

45. The method for improving the efficiency of the compression ignition internal combustion engine, as recited in claim 37, wherein the first desired engine output may be determined using adaptive predictive control circuitry.

46. The method for improving the efficiency of the compression ignition internal combustion engine, as recited in claim 45, wherein a sigma delta controller is used in the generation of the fuel injection instructions.

47. The method for improving the efficiency of the compression ignition internal combustion engine, as recited in claim 45, wherein the predictive adaptive control circuitry is selected from the group consisting of: a pulse width modulation controller, a least means square controller and a recursive least square controller.

48. The method for improving the efficiency of the compression ignition internal combustion engine, as recited in claim 45, wherein the predictive adaptive control circuitry includes feedback indicative of at least one of requested and actual working cycle firings.

49. The method for improving the efficiency of the compression ignition internal combustion engine, as recited in claim 48, wherein the generation of the fuel injection instructions is determined at least in part using predictive adaptive feedback control to provide the first desired engine output.

50. The method for improving the efficiency of the compression ignition internal combustion engine, as recited in claim 37, wherein air intake to the plurality of cylinders is constant over the succession of combustion cycles.

51. The method for improving the efficiency of the compression ignition internal combustion engine, as recited in claim 50, wherein fuel injection into each of the at least one of the plurality of cylinders is modulated to achieve the substantially optimal fuel to air ratio.

52. The method for improving the efficiency of the compression ignition internal combustion engine, as recited in claim 37, wherein the fuel injection instructions are dynamically calculated during operation of the engine on a working cycle by working cycle basis to provide the first desired engine output.

53. A system for improving efficiency of a compression ignition internal combustion engine having a plurality of cylinders capable of operating in a succession of combustion cycles by generating a non-uniform fueling profile to generate fueling efficiency gains, the system comprising:
a fuel processor configured to perform the steps of:
receiving a request for a first desired engine output;
generating fuel injection instructions to generate the non-uniform fueling profile across the plurality of cylinders which will produce a power output from the compression ignition internal combustion engine which substantially conforms to the first desired engine output, wherein said generating step comprises:
substantially controlling the regulation of fuel flow to a first subset of the plurality of cylinders at a substantially optimal efficiency fuel level during at least one of their respective working cycles, wherein the regulation of fuel flow to the first subset of the plurality of cylinders is determined by the generated fuel injection instructions, and wherein the optimal efficiency fuel level is determined from the ratio of fuel injected into the at least one cylinder to air drawn into the at least one cylinder which substantially maximizes fuel efficiency; and
substantially disabling fuel injection into to a second subset of the plurality of cylinders while the compression ignition internal combustion engine is in a first operational state corresponding to the first desired engine output, wherein the ratio of cylinders in the first subset of cylinders and the second subset of cylinders corresponds to the generated fuel injection instructions, and wherein the first subset of cylinders plus the second subset of cylinders equals the plurality of cylinders.

54. The system for improving the efficiency of the compression ignition internal combustion engine, as recited in claim 53, wherein the fuel processor is further configured to:
receive an updated request for a second desired engine output; and
substantially regulate fuel flow to at least one of the other of the plurality of cylinders at a higher fuel level, wherein the higher fuel level is dynamically determined to provide the second desired output for the engine.

55. The system for improving the efficiency of the compression ignition internal combustion engine, as recited in claim 53, wherein the fuel processor is further configured to receive at least one current operating condition including at least one of engine speed, wheel speed, air intake manifold flux, slope the vehicle is on, and movement resistance.

56. The system for improving the efficiency of the compression ignition internal combustion engine, as recited in claim 55, wherein the generating fuel injection instructions includes referencing the at least one current operating condition.

57. The system for improving the efficiency of the compression ignition internal combustion engine, as recited in claim 55, wherein the fuel processor is further configured to synchronize firing of the plurality of cylinders during their working cycles with the engine speed.

58. The system for improving the efficiency of the compression ignition internal combustion engine, as recited in claim 53, wherein the fuel processor includes a sigma delta control circuit configured to monitor the desired output and adaptively changing the number of cylinders in operation and adaptively varying the fueling of the at least one of the first subset of cylinders in order to deliver the desired output in accordance with variations in the desired output.

59. The system for improving the efficiency of the compression ignition internal combustion engine, as recited in claim 53, wherein the compression ignition internal combustion engine is a diesel engine.

60. The system for improving the efficiency of the compression ignition internal combustion engine, as recited in claim 53, wherein the compression ignition internal combustion engine is a homogenous charge compression ignition engine.

61. The system for improving the efficiency of the compression ignition internal combustion engine, as recited in claim 53, wherein the fuel processor comprises an adaptive predictive control circuitry adapted to determine the first desired engine output.

62. The system for improving the efficiency of the compression ignition internal combustion engine, as recited in claim 61, wherein the fuel processor comprises a sigma delta controller used in the generation of the fuel injection instructions.

63. The system for improving the efficiency of the compression ignition internal combustion engine, as recited in claim 61, wherein the predictive adaptive control circuitry is selected from the group consisting of: a pulse width modulation controller, a least means square controller and a recursive least square controller.

64. The system for improving the efficiency of the compression ignition internal combustion engine, as recited in claim 61, wherein the predictive adaptive control circuitry includes feedback indicative of at least one of requested and actual working cycle firings.

65. The system for improving the efficiency of the compression ignition internal combustion engine, as recited in claim 64, wherein the generation of the fuel injection instructions is determined at least in part using predictive adaptive feedback control to provide the first desired engine output.

66. The system for improving the efficiency of the compression ignition internal combustion engine, as recited in claim 53, wherein air intake to the plurality of cylinders is constant over the succession of combustion cycles.

67. The system for improving the efficiency of the compression ignition internal combustion engine, as recited in claim 66, wherein fuel injection into each of the at least one of the plurality of cylinders is modulated to achieve the substantially optimal fuel to air ratio.

68. The system for improving the efficiency of the compression ignition internal combustion engine, as recited in claim 53, wherein the fuel injection instructions are dynamically calculated during operation of the engine on a working cycle by working cycle basis to provide the first desired engine output.

69. A method for improving efficiency of a compression ignition internal combustion engine having a plurality of cylinders capable of operating in a succession of combustion cycles by generating a non-uniform fueling profile to generate fueling efficiency gains, the method comprising:
receiving a request for a first desired engine output;
generating fuel injection instructions to generate the non-uniform fueling profile across the plurality of cylinders which will produce a power output from the compression ignition internal combustion engine which substantially conforms to the first desired engine output, wherein said generating step comprises:
comparing the first desired engine output to the power output provided by the compression ignition internal combustion engine operating with all of the plurality of cylinders at a substantially optimal efficiency fuel level during every working cycle, wherein if the first desired engine output is less than power output provided by the compression ignition internal combustion engine operating with all of the plurality of cylinders at a substantially optimal efficiency fuel level during every working cycle then:
substantially controlling the regulation of fuel flow to a first subset of the plurality of cylinders at a substantially optimal efficiency fuel level during each of their respective working cycles, wherein the regulation of fuel flow to the first subset of the plurality of cylinders is determined by the generated fuel injection instructions, and wherein the optimal efficiency fuel level is determined from the ratio of fuel injected into the at least one cylinder to air drawn into the at least one cylinder which substantially maximizes fuel efficiency; and
substantially disabling fuel injection into to a second subset of the plurality of cylinders during each of their respective working cycles while the compression ignition internal combustion engine is in a first operational state corresponding to the first desired engine output, wherein the ratio of cylinders in the first subset of cylinders and the second subset of cylinders corresponds to the generated fuel injection instructions; else:
substantially controlling the regulation of fuel flow to at least one of the plurality of cylinders at the substantially optimal efficiency fuel level during each of their respective working cycles, wherein the regulation of fuel flow to the at least one of the plurality of cylinders is determined by the generated fuel injection instructions; and
substantially controlling the regulation of fuel flow to at least one of the other of the plurality of cylinders at a higher fuel level, wherein the higher fuel level is dynamically determined to provide the first desired output for the engine.
